(19) United States
(12) Patent Application Publication
(10) Pub. No.: US 2005/0060653 A1
(43) Pub. Date: Mar. 17, 2005

(54) Object operation apparatus, object operation method and object operation program

(75) Inventors: Masayuki Fukase, Kyoto (JP); Tomoko Yamashita, Kyoto (JP)

Correspondence Address: MCDERMOTT, WILL & EMERY, 600 13th Street, N.W., WASHINGTON, DC, 20005-3096, US

(73) Assignee: DAINIPPON SCREEN MFG. CO., LTD.

(21) Appl. No.: 10/936,504

(22) Filed: Sep. 9, 2004

(30) Foreign Application Priority Data
Sep. 12, 2003 (JP) JP2003-320575
Sep. 12, 2003 (JP) JP2003-320576

(51) Int. Cl. G11B 27/00; G06F 3/00

(52) U.S. Cl. 715/724; 715/827; 715/769

(57) ABSTRACT

A first icon displayed on a display is selected, and is specified by a source object specification section as a source object. Next, the first icon is dragged to the vicinity of a second icon (folder), so that the second icon is selected. Then, the first icon is dragged to the vicinity of third and fourth icons (folders) with a “Shift” key on a keyboard of an input device pressed, so that the third and fourth icons are selected. Next, the selected second to fourth icons are specified as target objects. The source object (file) is then copied to each of the target objects (folders).

### BACKGROUND OF THE INVENTION

1. Field of the Invention

The present invention relates to an object operation apparatus, an object operation method and an object operation program for displaying, on a display, files or folders for use in a computer in the form of objects in one-to-one correspondence with the files or folders, and carrying out a predetermined operation on the objects.

2. Description of the Background Art

In an operating system (OS) for use in a personal computer (hereinafter briefly referred to as a “computer”) such as Windows XP (a trademark of Microsoft Corp.) and Mac OS (a trademark of Apple Computer, Inc.), a graphical user interface (GUI) has been put into practice in which an object such as an icon representing a file, folder or the like is displayed on a display screen, and the icon is operated so that the file, folder or the like represented by the icon is copied or moved, for example.

That is, the OS can display a data file, an execution file for starting up a software application, a folder for storing these files and the like on a display in the form of icons (objects). An operator of a computer (hereinafter also briefly referred to as an “operator”) operates an input device of the computer to perform an operation in accordance with the display screen.

For instance, for moving a file existing in a folder (or directory) to another folder (or directory), an icon representing a source file is first specified through the input device of the computer. Specification of the icon is carried out by a pointing device such as a mouse or touch pad. An operator operates the input device to move a pointer onto the icon, and presses a button of the pointing device to highlight the icon pointed to by the pointer. Through such operation, the source file to be copied or moved is specified.

Subsequently, the operator operates the pointing device such that the pointer moves across the display with the button of the pointing device pressed. Then, the icon pointed to by the pointer also moves across the display. Such operation is called a “drag”.

This “drag” operation is continued until the source file is moved onto an icon representing a target directory. Then, the icon representing the target directory is highlighted, that is, the target directory is selected. Then, the operator releases the button of the pointing device having been pressed, on the icon representing the target directory. Such operation is called a “drop”. When the operator performs the “drop” operation on an icon, the OS moves the source file represented by the icon having been dragged by the pointer to the target directory.

In the case where the target directory is in a disk different from one that includes a directory in which the source file is originally stored, the OS copies the source file to the target directory.

As described, an operator of a computer equipped with an OS having a GUI performs a predetermined operation on an icon (object) displayed on a display using an input device, so that an operation such as copying or moving the displayed object can be performed. The drag and drop operation of icons is intuitively understandable, and hence, widely employed in file operations in computers.

In the conventional drag and drop operation, however, a plurality of icons can be dragged, but those icons can only be dropped on one icon. This causes a problem in that, for operating a plurality of files, the drag and drop operation using a pointing device needs to be performed repeatedly.

To solve this problem, various inventions have been disclosed.

However, the conventional technique does not sufficiently solve the problem in that an operation using a pointing device needs to be performed repeatedly.

That is, with the conventional technique, a plurality of icons (objects) cannot be selected by one drag, or one or more files cannot be copied or moved to a plurality of directories only by one drag and drop operation. Accordingly, an operator needs to perform the drag and drop operation several times in order to copy or move one or more files to a plurality of directories, which imposes operational burdens on the operator.

### SUMMARY OF THE INVENTION

The present invention is directed to an object operation apparatus in a computer system.

According to the present invention, the object operation apparatus comprises: a display for displaying thereon objects symbolically representing digital elements, respectively; a manual input device; a first specification section for specifying a first object among the objects displayed on the display in response to a first manual operation through the manual input device; a second specification section for continuously moving the first object to the vicinity of a plurality of second objects among the objects displayed on the display in response to a second manual operation through the manual input device performed with the first object kept specified, thereby specifying the plurality of second objects; and an operating section for performing a digital operation between a first digital element represented by the first object and each of a plurality of second digital elements represented by the plurality of second objects, respectively.

An operator is not required to repeat the digital operation for each of the plurality of second objects. This can reduce burdens in operating objects imposed on the operator.

According to an aspect of the invention, the object operation apparatus comprises: a display for displaying thereon objects symbolically representing digital elements, respectively; a manual input device; a first specification section for specifying a plurality of first objects among the objects displayed on the display in response to a first manual operation through the manual input device; a second specification section for moving the plurality of first objects to the vicinity of a plurality of second objects among the objects displayed on the display in response to a second manual operation through the manual input device performed with the plurality of first objects kept specified, thereby specifying the plurality of second objects; and an operating section for performing a digital operation between a plurality of first digital elements represented by the plurality of first objects, respectively, and a plurality of second digital elements represented by the plurality of second objects, respectively, in one-to-one correspondence with each other, on the basis of a correspondence between the plurality of first objects and the plurality of second objects. The plurality of first objects and the plurality of second objects are equal in number.

An operator is not required to repeat the digital operation for each of the plurality of second objects. This can reduce burdens in operating objects imposed on the operator.

According to another aspect of the present invention, the object operation apparatus comprises: a display for displaying thereon objects symbolically representing digital elements, respectively; a manual input device; a first specification section for specifying a first object among the objects displayed on the display in response to a first manual operation through the manual input device; a second specification section for moving the first object to the vicinity of a second object among the objects displayed on the display in response to a second manual operation through the manual input device performed with the first object kept specified, thereby specifying the second object; a retrieving section for searching the computer system to retrieve a third object having the same attribute as the second object; and an operating section for performing a digital operation between a first digital element represented by the first object and each of second and third digital elements represented by the second and third objects, respectively.

An operator is not required to specify a plurality of objects that correspond to the second object or perform an object operation repeatedly. This can reduce burdens in operating objects imposed on the operator.

It is therefore an object of the present invention to improve the efficiency in operating objects displayed on the display.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the configuration of an object operation apparatus according to first and second preferred embodiments of the present invention;

FIG. 2 is a flow chart of a process performed by the object operation apparatus shown in FIG. 1, describing continuous specification of target objects;

FIG. 3 is another flow chart of a process performed by the object operation apparatus shown in FIG. 1, describing sequential specification of target objects;

FIGS. 4A to 4D are explanatory views of a process of continuously specifying target objects;

FIGS. 5A to 5D are explanatory views of a process of sequentially specifying target objects;

FIG. 6 is another flow chart of a process performed by the object operation apparatus shown in FIG. 1, describing specification of a plurality of source objects and continuous specification of target objects;

FIGS. 7A to 7D are explanatory views of a process of specifying a plurality of source objects and continuously specifying a plurality of target objects;

FIG. 8 is another flow chart of a process performed by the object operation apparatus shown in FIG. 1, describing specification of a plurality of source objects and sequential specification of a plurality of target objects;

FIGS. 9A to 9D are explanatory views of a process of specifying a plurality of source objects and continuously specifying a plurality of target objects;

FIG. 10 shows the configuration of an object operation apparatus according to third and fourth preferred embodiments of the invention;

FIG. 11 is a flow chart of a process performed by the object operation apparatus shown in FIG. 10;

FIGS. 12A to 12E are explanatory views of a drag and drop operation on a display performed by the object operation apparatus shown in FIG. 10;

FIG. 13 is a flow chart of a process performed by the object operation apparatus shown in FIG. 10;

FIG. 14 shows icon properties;

FIGS. 15A to 15C are explanatory views of a process performed by a target file attribute assigning section;

FIGS. 16A to 16C are explanatory views of an association operation performed by an associating section; and

FIGS. 17A and 17B are explanatory views of a shortcut menu operation on the display performed by the object operation apparatus shown in FIG. 10.

### DESCRIPTION OF THE PREFERRED EMBODIMENTS

Hereinbelow, preferred embodiments of the present invention will be discussed.

### First Preferred Embodiment

### 1-1. Configuration of Object Operation Apparatus

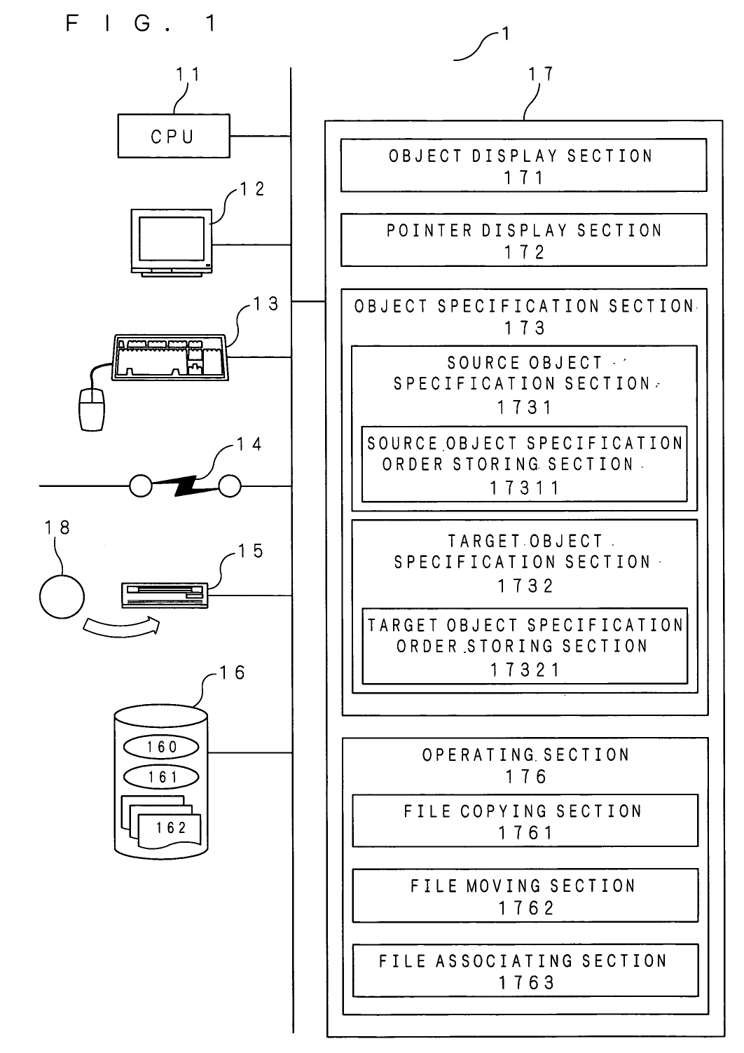

FIG. 1 shows the configuration of an object operation apparatus 1 according to the present invention. The object operation apparatus 1 is a computer system configured by a general-purpose personal computer, including a CPU11, a display 12, an input device 13, a network I/F (interface) 14, a media drive 15, a storage 16 and a memory 17.

The CPU11 executes an operation in accordance with an OS 160 stored in the storage 16, for controlling operational conditions of hardware and software implemented in the computer. Further, the CPU11 executes a program 161 recorded in a media disk 18 inserted into the media drive 15, at the memory 17, for performing the functions of the object operation apparatus 1.

The display 12 is used to display information necessary for an object operation. That is, the display 12 displays objects such as icons, a pointer for pointing to objects, and the like.

The input device 13 includes a mouse (or pointing device) and a keyboard (or key device). An operator operates the input device 13 in accordance with the display 12 to input an instruction to the object operation apparatus 1, thereby executing a predetermined operation. For instance, the operator operates the pointer displayed on the display 12 using the input device 13, thereby specifying an object and moving the pointer. That is, the input device 13 is used as a manual input device.

The network I/F14 is provided for connecting the object operation apparatus 1 and a network not shown. The object operation apparatus 1 is capable of downloading the program 161 for achieving the functions of the object operation apparatus 1 from a server not shown through the network I/F14.

The media drive 15 is used to read the program 161 recorded in the media disk 18. The functions of the object operation apparatus 1 are achieved by the program 161 read by the media drive 15.

The storage 16 stores the OS 160 necessary for executing operations of the object operation apparatus 1. The program 161 read by the media drive 15 is also stored in the storage 16. Further, a plurality of files 162 to be operated in a process which will be described later are also stored in the storage 16.

The OS 160 is an operating system for controlling a personal computer which configures the object operation apparatus 1. The OS 160 is executed by the CPU11, so that a file operation is achieved in the personal computer. Further, through the functions of the OS 160, the objects and pointer are displayed on the display 12, and the pointer is operated by the input device 13.

The program 161 is for performing an object operation according to the present invention in the object operation apparatus 1. The file 162 contains electronic data to be processed by the object operation performed by the object operation apparatus 1. The file 162 is managed by the OS 160 and is assigned a path that defines an electronic location of the file 162. Here, a path is synonymous with a directory generally used in computerese, and the file 162 is managed by the storage 16 as being stored in a directory in accordance with the path assigned thereto.

The OS 160 and the whole or part of program 161 stored in the storage 16 is copied to the memory 17. The CPU11 then executes an operation in accordance with the OS 160 and the program 161 stored in the storage 16. That is, the memory 17 is used as a work memory of the CPU11. For instance, the OS 160 is executed by the CPU11 at the memory 17, so that the functions of an object display section 171 and a pointer display section 172 are performed. Also, the program 161 is executed by the CPU11, so that the functions of an object specification section 173 and an operating section 176 are performed at the memory 17.

The object display section 171 displays the file 162 stored in the storage 16 on the display 12 in the form of an object such as an icon. In other words, an object displayed on the display 12 represents the file 162 which is a digital element stored in the storage 16, and symbolically represents the digital element. Further, the display 12 can also display a directory managed by the OS 160 in the form of an object by obtaining a path to the directory. A directory displayed on the display 12 in the form of an object is particularly called a folder. As described, the object display section 171 displays an object symbolically representing a digital file or digital folder.

The pointer display section 172 displays the pointer to be operated by the input device 13 on the display 12, and moves the pointer across the screen of the display 12 in accordance with an input through the input device 13.

The object specification section 173 selects and specifies an object displayed by the object display section 171 in accordance with an input through the input device 13. Specifically, the object specification section 173 selects and specifies a source object (or first object) highlighted with a click of the button (not shown) of the pointing device of the input device 13 with the pointer located on the source object, and a target object (or second object) highlighted with the pointer holding the source object located in the vicinity of the target object. Alternatively, the source object can be specified using a shortcut menu displayed by operating a button (not shown) of the pointing device of the input device 13.

The object specification section 173 includes a source object specification section 1731 and a target object specification section 1732.

When the pointer displayed by the pointer display section 172 points to an object to be operated in accordance with an input through the input device 13, the source object specification section 1731 specifies the object as a source object. That is, the source object is specified in response to a manual operation performed by an operator through the input device 13.

In this manner, the source object specification section 1731 highlights or selects one or more objects displayed on the display 12 in accordance with an input through the input device 13, and specifies the selected object as a source object.

Accordingly, a source object can be specified that represents a file or folder (digital element) such as a file to be moved or copied, or a file with which an association is to be established.

Object specification by the source object specification section 1731 can be performed by a drag and drop operation performed by operating the pointer through the input device 13 or using a shortcut menu displayed by operating a button (not shown) of the pointing device of the input device 13.

The object specification section 173 includes a source object specification order storing section 17311. In the case where a plurality of source objects are specified by the object specification section 173, the specification order storing section 17311 stores the order of specification of the plurality of source objects.

For instance, in the case where the source objects are sequentially specified by the source object specification section 1731, the specified objects are stored in the specification order storing section 17311 in association with their positions in the order of specification.

Then, the order of specification of the source objects as stored is referred to when performing an object operation on files or folders (digital elements) represented by the plurality of source objects in one-to-one correspondence with files or folders represented by a plurality of target objects (which will be discussed later in detail).

When the pointer displayed by the pointer display section 172 points to a plurality of target objects in accordance with an input through the input device 13, the target object specification section 1732 specifies the plurality of objects as target objects. That is, the target objects are specified in response to a manual operation performed by an operator through the input device 13 with the source objects kept specified.

As described, in specifying target objects by the target object specification section 1732, one or more source objects specified by the source object specification section 1731 are first held and dragged while the pointer sweeps in the vicinity of a plurality of objects displayed on the display 12 other than the source objects, so that the plurality of objects are highlighted or selected. The target object specification section 1732 specifies the selected plurality of objects as target objects.

Accordingly, a plurality of target objects can be specified that represent target files or folders such as objects representing folders to which source files are to be moved or copied, or objects representing files with which an association is to be established.

Note that a plurality of target objects are specified by the target object specification section 1732 by pressing a certain key, e.g., a “Shift” key on the keyboard of the input device 13 in addition to the drag and drop operation performed with the pointer operated through the input device 13.

When the pointer passes over an object with the “Shift” key on the keyboard of the input device 13 pressed by the operator, the target object specification section 1732 specifies the object as a target object, thereby continually specifying a plurality of target objects.

Specifically, in the case where objects to be specified as target objects are located adjacently to each other on the display 12, object specification is performed by the following steps.

(1) First, the operator operates the input device 13 to drag a source object to the vicinity of one of objects which are to be specified by the target object specification section 1732 (hereinafter also referred to as a “to-be-selected object”). The to-be-selected object is thereby highlighted.

(2) Next, upon confirming that the to-be-selected object is highlighted, the source object is dragged with the “Shift” key on the keyboard of the input device 13 pressed. Accordingly, objects present in the vicinity of a route followed by the source object while the “Shift” key is pressed are highlighted.

Specifically, an object selection signal is continuously transmitted to the CPU11 from the keyboard while the “Shift” key is pressed. The CPU11 highlights or selects objects present in the vicinity of the dragged source object while receiving the object selection signal. In the present embodiment, the object selection signal continuously transmitted to the CPU11 is also called a “continuous selection signal”.

(3) Then, upon confirming that the plurality of objects located adjacently to each other are all highlighted through the steps (1) and (2), the operator releases the “Shift” key. Then, the target object specification section 1732 specifies the plurality of highlighted objects as target objects. Accordingly, objects displayed on the display 12 can be continuously specified as a plurality of target objects.

In the step (3), the plurality of highlighted objects may be specified as target objects not only when the operator releases the “Shift” key, but also when the dragging of the source object is released (i.e., the button (not shown) of the pointing device of the input device 13 is released).

Further, specification of a plurality of objects by the target object specification section 1732 may be performed not only continuously as described above, but also sequentially by pressing a certain key, e.g., a “Ctrl” key on the keyboard of the input device 13.

When the operator presses the “Ctrl” key on the keyboard of the input device 13 with the pointer located on an object, the target object specification section 1732 specifies the object as a target object. When the operator presses the “Ctrl” key with the pointer operated by the operator to be located on another object, the target object specification section 1732 also specifies the object as a target object. With such operation repeatedly performed by the operator, the target object specification section 1732 can sequentially specify a plurality of target objects.

Specifically, sequential specification of a plurality of target objects is performed by the following steps.

(1) First, the operator moves a source object to the vicinity of a to-be-selected object similarly in the case of continuously specifying target objects. The to-be-selected object is thereby highlighted.

(2) Next, upon confirmation that the pointer is located on the to-be-selected object, the operator presses the “Ctrl” key on the keyboard of the input device 13. The highlighted to-be-selected object is thereby additionally specified as one of target objects to be specified.

Specifically, when the “Ctrl” key is pressed, the object selection signal is transmitted to the CPU11 from the keyboard. The target object specification section 1732 having received this selection signal specifies a highlighted object located in the vicinity of a dragged source object as a target object. In the present embodiment, the object selection signal transmitted to the CPU11 in synchronization with the pressing of the “Ctrl” key is also called an “intermittent selection signal”.

(3) Repeating the steps (1) and (2), a plurality of target objects can be specified sequentially. In this manner, the pointer PO holding the source object visits another object displayed on the display 12, so that the target object specification section 1732 specifies the object as a target object.

The target object specification section 1732 further includes a target object specification order storing section 17321. The storing section 17321 stores the order of specification of a plurality of target objects specified by the target object specification section 1732.

For instance, in the case where target objects are sequentially specified by the target object specification section 1732, the specified objects are stored in the storing section 17321 in association with their positions in the order of specification.

The order of specification of target objects as stored is referred to when operating a file (digital element) represented by the source object with respect to files or folders represented by the plurality of target objects, and also when operating files or folders represented by a plurality of source objects with respect to files or folders represented by the plurality of target objects in one-to-one correspondence with each other (both cases will be discussed later).

The operating section 176 operates a file represented by a source object specified by the source object specification section 1731 with respect to a file or folder represented by a target object specified by the target object specification section 1732. That is, the operating section 176 executes a digital operation (hereinafter also referred to as an “object operation”) such as file copying, file moving and file association to be described later between the file represented by the source object and the file or folder represented by the target object. For this purpose, the operating section 176 includes a file copying section 1761, a file moving section 1762 and a file associating section 1763.

When the target object specified by the target object specification section 1732 represents a folder (or directory), the file copying section 1761 copies a file represented by the source object to the directory represented by the target object.

Specifically, the file copying section 1761 executes file copying by the following steps. (1) First, the file copying section 1761 obtains a path to the folder representing the target object as an attribute of the target object.

(2) Next, the file copying section 1761 copies the file represented by the source object, and assigns the path obtained from the folder represented by the target object to the copied file. That is, file data corresponding to the source object (e.g. text data in the case of a text file) is copied, and a path portion of attributes of the copied file is replaced by the path obtained in the step (1). The file represented by the source object is thereby copied to the directory represented by the target object.

When the target object specified by the target object specification section 1732 represents a folder (or directory), the file moving section 1762 moves the file represented by the source object to the directory represented by the target object.

Specifically, the file moving section 1762 executes file moving by the following steps. (1) First, the file moving section 1762 obtains a path to the folder represented by the target object as an attribute of the target object.

(2) Next, a path to the file represented by the source object is replaced by the path obtained in the step (1). The file represented by the source object can thereby be moved to the directory represented by the target object.

The above-described file copying by the file copying section 1761 and file moving by the file moving section 1762 may be performed using the functions of the OS 160.

When the target object specified by the target object specification section 1732 represents a file, the file associating section 1763 associates the file represented by the source object with the file represented by the target object.

Specifically, the file associating section 1763 executes an operation of adding information on the file or folder represented by the source object (e.g., path information of the file or folder) to the file represented by the target object. This operation is, for example, writing path information of the file represented by the source object in a certain portion (e.g., the header) of the file represented by the target object as a file attribute. Accordingly, the file with which an association is established (i.e., the file represented by the target object) can be retrieved on the basis of the written attribute.

The file associating section 1763 establishes an association by the following steps. (1) First, the file associating section 1763 obtains an attribute of the target object or an attribute of the file represented by the target object, to judge whether it is possible to establish an association with the file represented by the source object.

In the case where it is judged that an association is possible in the step (1), the file associating section 1763 associates the file represented by the source object with the file represented by the target object.

For an association established by the file associating section 1763, an association by linking or incorporating the file represented by the source object into the file represented by the target object may be employed.

Even when an object represents a folder in which files are stored, operations of the object display section 171, source object specification section 1731, target object specification section 1732 and operating section 176 can be performed considering the folder as one file.

Specifically, before performing an object operation, the operating section 176 checks in advance respective attributes of the source object and target object, to judge whether or not the object operation is possible. Accordingly, there arises no problem in the object operation even if the source object and target object are considered as files, respectively.

Similarly, as to a display operation performed by the object display section 171 and object specification performed by the source object specification section 1731 and target object specification section 1732, predetermined operations can be performed by checking attributes of source and target objects without distinguishing whether each object represents a file or folder.

Further, since a file and a folder can be distinguished from each other by checking their attributes, files and folders can be managed as files 162 in the storage 16.

### 1.2. Process of Object Operation

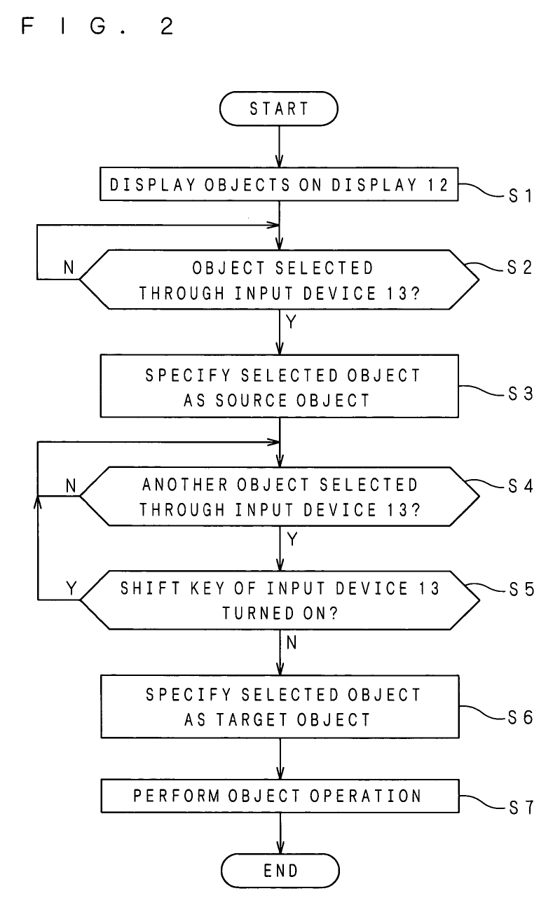

FIG. 2 is a flow chart of a process performed by the object operation apparatus 1, and particularly describes continuous specification of target objects. Here, it is assumed that no object has been specified by the source object specification section 1731 or the target object specification section 1732 at a stage prior to the execution of step S1 shown in FIG. 2.

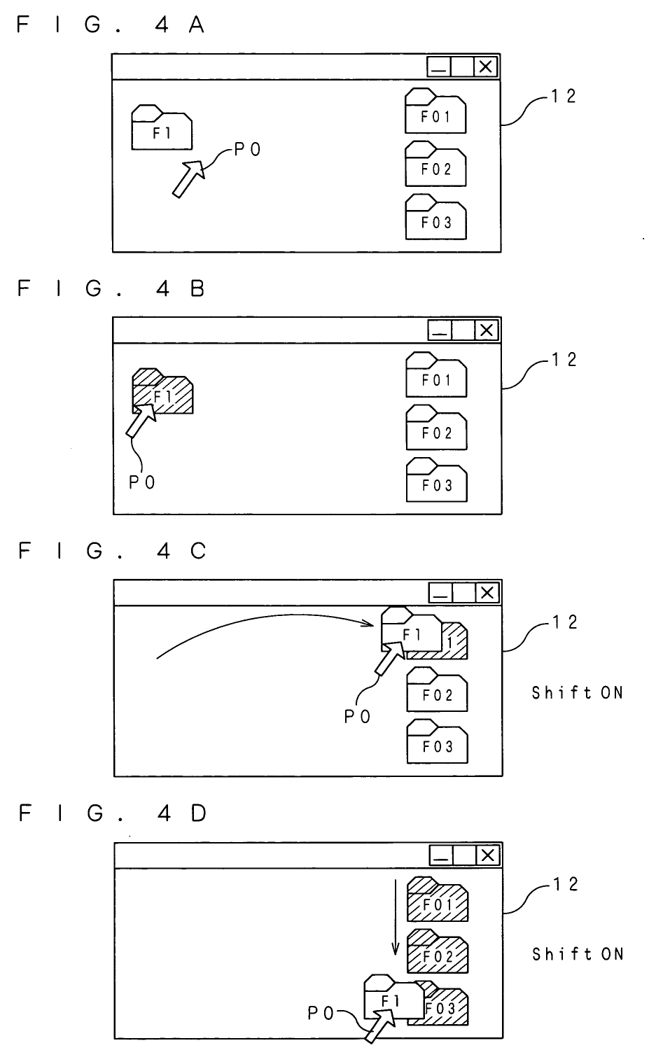

First, in step S1, objects are displayed on the display 12 prior to an object operation. Specifically, objects representing files 162 (not only so-called files, but also folders) stored in the storage 16 are displayed on the display 12 (see FIG. 4A which will be described later).

Here, objects displayed on the display 12 are commonly called “icons”, and the operator operates the input device 13 to specify icons displayed on the display 12 and perform a predetermined operation (object operation) among a plurality of icons.

In step S2, the operator operates the input device 13, to check whether or not an icon (object) displayed on the display 12 is selected. When it is judged that the icon is highlighted or selected (see FIG. 4B which will be described later), the highlighted icon is specified as a source object by the source object specification section 1731 (step S3). When the icon is not highlighted, and it is therefore judged that the icon is not selected, step S2 is repeated.

Here, object specification by the object specification section 173 can be performed with a click of a button of the pointing device of the input device 13 with the pointer located on the object.

In step S4, the source object specified in step S3 is dragged, so that it is checked whether or not any object displayed on the display 12 other than the specified object is highlighted. When it is judged that no other object is highlighted or selected, step S4 is repeated.

On the other hand, when it is judged that any object other than the source object is highlighted or selected (see FIG. 4C which will be described later), a further judgment is made whether or not the “Shift” key on the keyboard of the input device 13 is pressed by the operator (step S5).

Then, when it is judged that the “Shift” key is pressed to be brought into the ON state in step S5, objects located in the vicinity of a route followed by the source object being dragged with the “Shift” key pressed are highlighted or selected (step S4; see FIG. 4D which will be described later). In this manner, continuing dragging the source object with the “Shift” key in the ON state, objects located in the vicinity of the route followed by the source object can additionally be highlighted.

On the other hand, when the operator releases the “Shift” key to be brought into the OFF state from the ON state (step S5), the target object specification section 1732 specifies the highlighted or selected objects as target objects (step S6).

In step S7, an object operation is performed between the source object specified in steps S2 and S3 and the target objects specified in steps S4 and S5. Specifically, the CPU11 first confirms whether or not dragging of the source object is released (i.e., whether or not the button (not shown) of the pointing device of the input device 13 is released).

When it is judged that the dragging is released, the operating section 176 judges whether the source object specified by the source object specification section 1731 represents a file or folder, and judges whether the plurality of target objects specified by the target object specification section 1732 represent files or folders.

Then, the process is completed after a predetermined object operation is performed between the file or folder represented by the source object and the files or folders represented by the plurality of target objects.

For instance, in the case where the source object represents a file and the plurality of target objects each represent a folder, the file represented by the source object is copied or moved to each of folders represented by the plurality of target objects.

In the case where each of the source object and the plurality of target objects represents a file, an association is established that writes information on the source object into each of the files represented by the plurality of target objects.

As described, the object operation apparatus 1 is capable of repeating steps S4 and S5 in the flow chart shown in FIG. 2, and hence continually specifying target objects. The object operation can thereby be performed between the source object and each of the plurality of target objects.

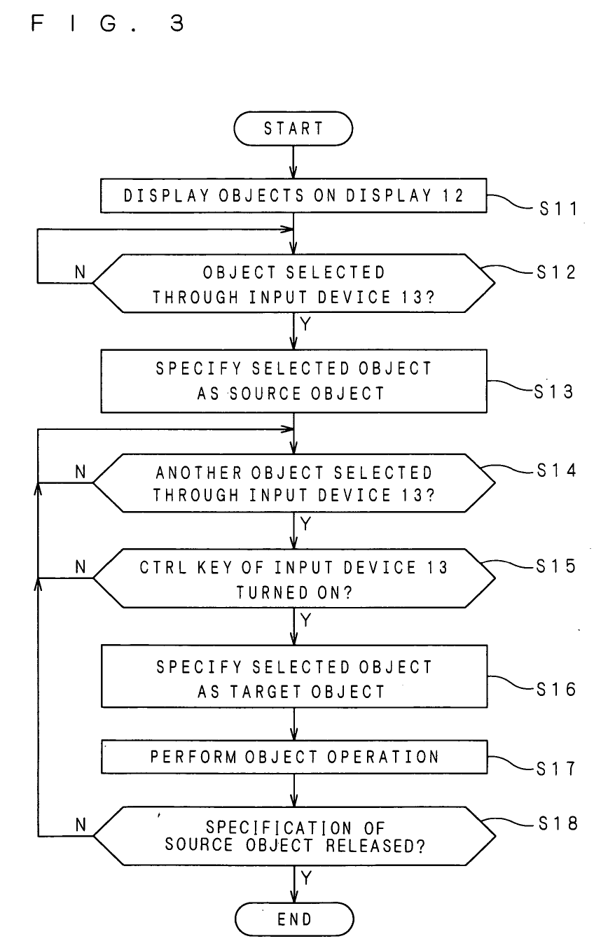

FIG. 3 is another flow chart of a process performed by the object operation apparatus 1, describing sequential specification of target objects. Here, it is assumed that no object has been specified by the source object specification section 1731 or the target object specification section 1732 at a stage prior to the execution of step S11 shown in FIG. 3.

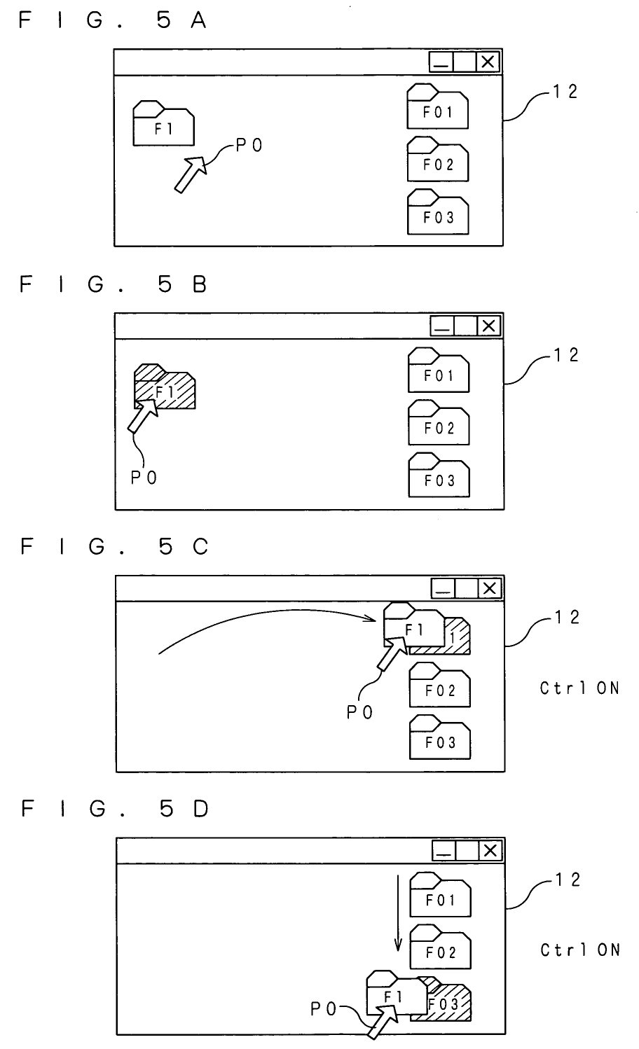

Steps S11 to S13 are similar to steps S1 to S3 shown in FIG. 2. That is, in step S11, objects are displayed on the display 12 prior to an object operation (see FIG. 5A which will be described later). Next, the input device 13 is operated, to specify a highlighted or selected object as a source object (steps S12 and S13; see FIG. 5B which will be described later).

In step S14, the source object specified in step S13 is dragged, so that it is checked whether or not any object displayed on the display 12 other than the specified object is highlighted. When it is judged that no other object is highlighted or selected, step S14 is repeated.

On the other hand, when it is judged that an object other than the source object is highlighted or selected (see FIG. 5C which will be described later), a further judgment is made whether or not the “Ctrl” key on the keyboard of the input device 13 is pressed by the operator (step S15).

Then, when it is judged that the “Ctrl” key is pressed, a highlighted object located under the pointer is specified as a target object by the target object specification section 1732 (step S16). In other words, the highlighted object with the “Ctrl” key pressed is specified as a target object.

In step S17, an object operation is performed between the source object specified in steps S12 and S13 and the target object specified in steps S14 to S16. Then, a predetermined object operation is performed between the file or folder represented by the source object and each of the files or folders represented by the plurality of target objects.

Subsequently, in step S18, it is checked whether or not dragging of the source object is released (i.e., whether or not the button (not shown) of the pointing device of the input device 13 is released), and thus, whether or not specification of the source object is released.

When it is judged that specification of the source object is not released, steps S14 to S17 are repeated, so that an object operation is performed between newly specified target objects and the source object specified in steps S12 and S13 (see FIG. 5D which will be described later). Accordingly, an object operation is performed between the source object and each of the sequentially specified plurality of target objects.

On the other hand, when it is judged that specification of the source object is released, the process is finished considering that the object operation has been completed.

As described, the object operation apparatus 1 is capable of repeating steps S14 to S17 in the flow chart shown in FIG. 3, and hence sequentially specifying target objects. The object operation can thereby be performed between the file or folder represented by the source object and each of the files or folders represented by the plurality of target objects.

### 1.3. Display in Object Operation

FIGS. 4A to 4D illustrate the state of the display 12 in which the object operation apparatus 1 operates in accordance with the flow chart shown in FIG. 2.

FIG. 4A shows the state in which the object display section 171 and pointer display section 172 display a source icon FI, target icons FO1 to FO3 and a pointer PO on the display 12. Here, with a drag and drop operation of the source icon FI to the target icons FO1 to FO3, a predetermined object operation is performed between a file or folder represented by the source icon FI and each of files or folders represented by the target icons FO1 to FO3.

FIG. 4B shows the state in which the operator operates the input device 13 to move the pointer PO onto the source icon FI, and presses the button of the pointing device of the input device 13. With such operation of the input device 13 by the operator, the source object specification section 1731 specifies an object pointed to by the pointer PO as a source object. Here, the source icon FI is specified as the source object.

The object display section 171 highlights the source object so as to be distinguishable from other objects. Accordingly, the operator can easily judge which one of objects displayed on the display 12 has been specified as a source object. FIG. 4B shows that the source icon FI specified as a source object is hatched and is specified as a source object by hatching.

FIG. 4C shows the state in which the operator operates the input device 13 to move the pointer PO onto the target icon FO1 with the source icon FI held and dragged. When the operator moves the pointer PO while pressing the button of the pointing device of the input device 13, the source icon FI also moves together with the pointer PO. The operator operates the input device 13 to move the pointer PO onto the target icon FO1 while holding the source icon FI. When the pointer PO holding the source icon FI is located on the target icon FO1, the target icon FO1 is highlighted or selected.

The object display section 171 highlights an object displayed on the display 12 in order to show that the object is selected. FIG. 4C shows that the target icon FO1 is specified by hatching.

In common computers, when the operator releases the button of the pointing device of the input device 13 in the state shown in FIG. 4C, the drag and drop operation is completed.

In contrast, the object operation apparatus 1 shown in FIG. 1 is capable of continuously selecting objects by pressing the “Shift” key on the keyboard of the input device 13 in the state shown in FIG. 4C.

FIG. 4D shows the state in which the pointer PO holding the source icon FI is moved from the position shown in FIG. 4C with the “Shift” key on the keyboard of the input device 13 pressed. In this state, when the operator operates the input device 13 such that the source object passes in the vicinity of the icons FO2 and FO3, the icons FO2 and FO3 are also selected.

The object display section 171 also highlights the icons FO2 and FO3 to show that these icons are also selected. Here, hatching shows that the icons FO2 and FO3 are selected, similarly to the target icon FO1 (see FIG. 4D).

Upon confirmation that icons to be specified (in FIG. 4D, the target icons FO1, FO2 and FO3) are highlighted on the display 12, the operator releases the button of the pointing device of the input device 13.

Accordingly, the icons FO1, FO2 and FO3 are specified as target objects by the target object specification section 1732. Then, an object operation is performed between the source icon FI and each of the icons FO1 to FO3 similarly to dropping the icon FI onto each of the icons FO1 to FO3.

That is, in response to this operation similar to dropping the icon FI onto each of the icons FO1 to FO3, the operating section 176 activates the file copying section 1761, file moving section 1762 or file associating section 1763 to execute an object operation between the file or folder represented by the source icon FI and each of the files or folders represented by the target icons FO1 to FO3.

As described, the object operation apparatus 1 shown in FIG. 1 is capable of continuously specifying a plurality of target icons with the dragging of the pointer PO holding the source icon FI with the Shift key on the keyboard pressed while the button of the pointing device of the input device 13 is pressed by the operator.

FIGS. 5A to 5D illustrate the state of the display 12 in which the object operation apparatus 1 is operated in accordance with the flow chart shown in FIG. 3. FIGS. 5A and 5B show states similar to those in FIGS. 4A and 4B, explanation of which is omitted here.

FIG. 5C shows the state in which the operator operates the input device 13 to move the pointer PO onto the target icon FO1 with the source icon FI held and dragged. When the pointer PO holding the icon FI specified as a source object is moved to locate on the target icon FO1, the operator presses the “Ctrl” key on the keyboard. Then, the target icon FO1 is specified as a target object. Accordingly, an object operation is performed between the source object as dragged and the target object specified by pressing the “Ctrl” key, similarly to an object operation when the source icon FI is dropped onto the target icon FO1.

Specifically, the target object specification section 1732 specifies the target icon FO1 as a target object. The operating section 176 activates the file copying section 1761, file moving section 1762 or file associating section 1763 to execute an object operation between the file or folder represented by the source icon FI and each of the files or folders represented by the target icons FO1 to FO3.

FIG. 5D shows the state in which the operator operates the input device 13 to move the pointer PO holding the source icon FI to locate on the target icon FO3. In the state shown in FIG. 5D, the operator presses again the “Ctrl” key on the keyboard of the input device 13 to perform an object operation similar to dropping the source icon FI onto the target icon FO3.

As a result, similarly to the step shown in FIG. 5C, the operating section 176 activates the file copying section 1761, file moving section 1762 or file associating section 1763 to perform an object operation between the file or folder represented by the source icon FI and the file or folder represented by the target icon FO3.

In the state shown in FIG. 5D, the same operation as the conventional drop operation is performed when the operator releases the button of the pointing device without pressing the “Ctrl” key on the keyboard of the input device 13. At this time, the source object specification section 1731 cancels source object specification on the source icon FI.

As described, in the object operation apparatus 1 shown in FIG. 1, the operator presses the “Ctrl” key on the keyboard while pressing the button of the pointing device of the input device 13, so that a similar operation to the drop operation without interrupting the drag operation with the pointer. This enables sequential specification of a plurality of target icons with the source icon FI held by the pointer PO.

### 1.4. Advantage of Object Operation Apparatus according to First Preferred Embodiment

As described above, the object operation apparatus 1 according to the first preferred embodiment operates in accordance with the flow chart shown in FIG. 2 and/or that of FIG. 3, to thereby specify a plurality of target objects, and the operating section 176 can perform an object operation between a file or folder represented by a source object and each of files or folders represented by the plurality of target objects.

That is, the conventional drag and drop operation enables a one-to-one or many-to-one object operation between one or more source objects and one target object. In contrast, the object operation apparatus 1 according to the present invention enables a one-to-many or many-to-many object operation between one or more source objects and a plurality of target objects, in addition to the conventional one-to-one or many-to-one object operation.

This eliminates the need to perform the drag and drop operation in specifying each of target objects after specifying a source object, which can reduce burdens in operating objects imposed on an operator.

### Second Preferred Embodiment

Next, a second preferred embodiment of the present invention will be discussed. The object operation apparatus 1 according to this embodiment is the same as in the first preferred embodiment except the process of object operation. The following discussion will be focused on this difference.

### 2.1. Process of Object Operation

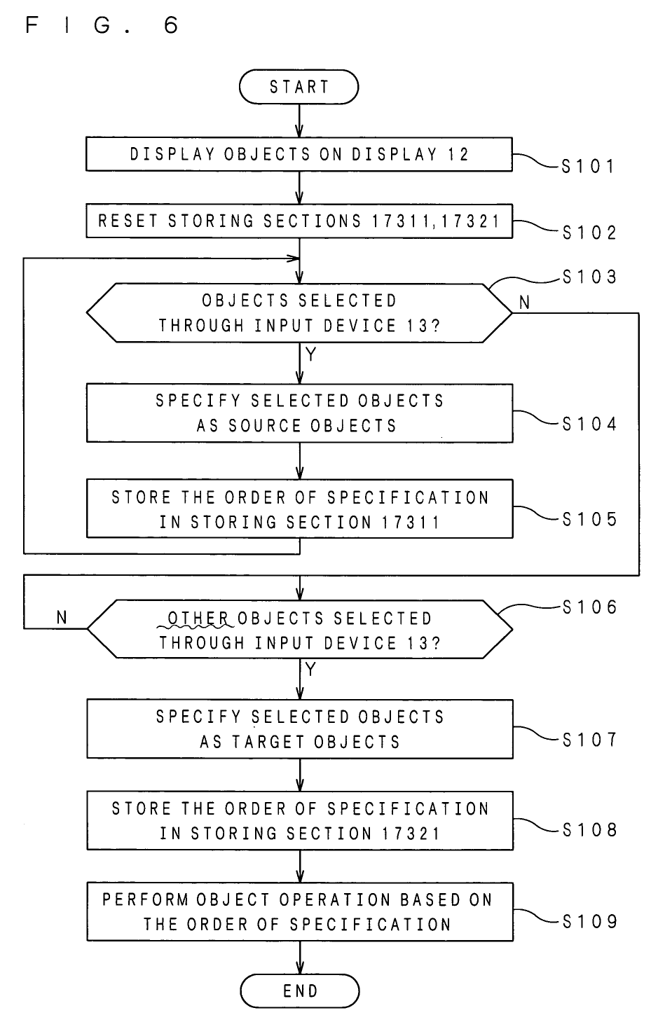

FIG. 6 is a flowchart showing a process of an object operation performed between files or folders represented by a plurality of source objects and files or folders represented by a plurality of target objects in one-to-one correspondence with each other.

Step S101 is similar to step S1 shown in FIG. 2 and step S11 shown in FIG. 3, in which objects are displayed on the display 12 prior to an object operation.

In step S102, the specification order storing section 17311 provided in the source object specification section 1731 and the specification order storing section 17321 provided in the target object specification section 1732 are both reset.

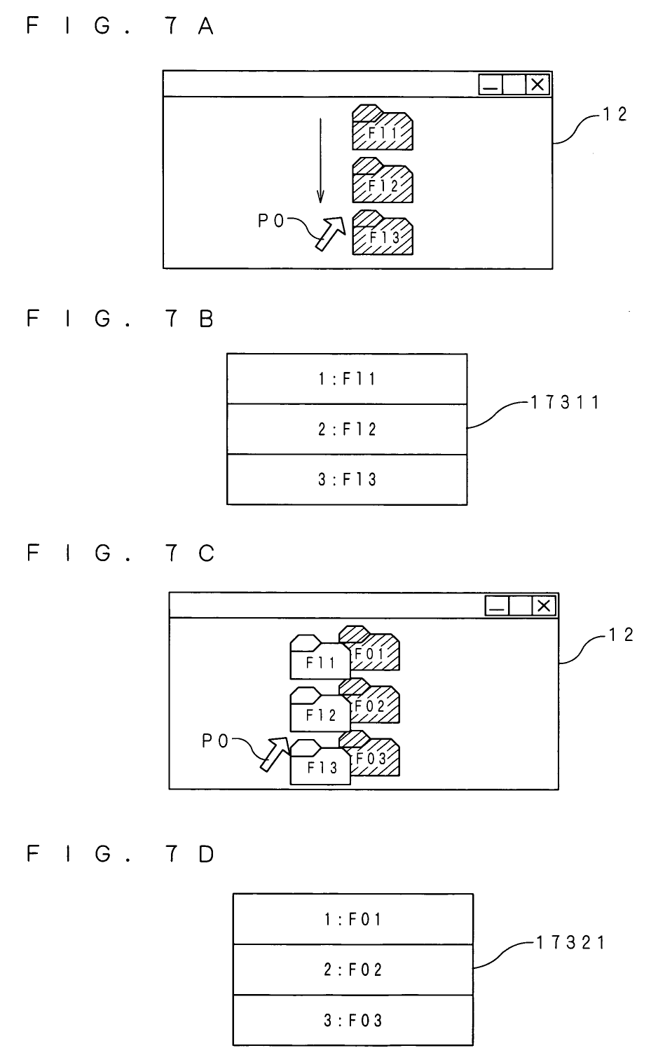

In step S103, the operator operates the input device 13 to check whether or not icons (objects) displayed on the display 12 are selected. When it is judged that the icons are highlighted or selected (see FIG. 7A), the source object specification section 1731 specifies the highlighted icons as source objects (step S104), and the order of specification of the icons is stored in the specification order storing section 17311 (step S105). That is, as shown in FIG. 7B, the specification order storing section 17311 stores the specified objects in association with their positions in the order of specification.

Repeating steps S103 to S105, the source object specification section 1731 can specify a plurality of source objects necessary for an object operation.

Here, steps S103 to S105 will be discussed referring to the display 12. FIG. 7A specifically shows steps S103 to S105. As shown in FIG. 7A, source icons FI1 to FI3 and the pointer PO are displayed on the display 12.

First, the operator operates the input device 13 to move the pointer, so that the source icon FI1 is selected. Then, the source object specification section 1731 specifies the source icon FI1 as a source object (steps S103 and S104), and the specification order storing section 17311 stores the source icon FI1 as a first one in the order of specification (step S105).

Repeating steps S103 and S104 in accordance with an input through the input device performed by the operator, the source object specification section 1731 specifies the source icons FI2 and FI3 in this order as source objects. Then, the specification order storing section 17311 stores the source icons FI2 and FI3 as the second and third ones in the order of specification, respectively (step S105, see FIG. 7B).

As a result, as shown in FIG. 7B, the specification order storing section 17311 stores the order of specification of the plurality of source objects. For instance, when the source icons FI1 to FI3 are specified in this order by the source object specification section 1731, the order of specification of the source objects is stored as “1st: FI1”, “2nd: FI2” and “3rd: FI3”.

Referring back to FIG. 6, upon completion of specification of the source objects and storing of the order of specification in steps S103 to S105, target objects are specified in steps S106 and S107. Specifically, in step S106, the object specification section 173 checks whether or not objects displayed on the display 12 other than the source objects are highlighted similarly to step S103 with the dragging of the plurality of source objects performed by an input through the input device 13. When the object specification section 173 judges that no other object is highlighted or selected, step S106 is repeated.

On the other hand, when it is judged that objects other than the source object are highlighted or selected (see FIG. 7C), the dragging of the source objects is released. Then, the icons FO1 to FO3 selected by locating the source icons FI1 to FI3 thereon, respectively, are specified as target objects (step S107), and the order of specification is stored in the specification order storing section 17321 (step S108: see FIG. 7D).

Here, steps S106 to S108 will be discussed referring to the display 12. FIG. 7C specifically shows steps S106 to S108. As shown in FIG. 7C, the target icons FO1 to FO3 and the pointer PO are displayed on the display 12.

The operator operates the input device 13 to move the pointer PO to locate on the target icons FO1 to FO3 with the source icons FI1 to FI3 shown in FIG. 7A held by the pointer PO. Then, the target object specification section 1732 specifies the target icons FO1 to FO3 as target objects (steps S106 and S107).

Upon completion of specification of the target objects by the target object specification section 1732, the order of specification of the target icons FO1 to FO3 is stored in the specification order storing section 17321 (step S108; see FIG. 7D). The number of source objects and that of target objects are the same, and three in this embodiment.

As shown in FIG. 7C, the source icons FI1 to FI3 are dragged to locate on the corresponding target icons FO1 to FO3, respectively, so that the target icons FO1 to FO3 are selected. Therefore, the specification order storing section 17321 stores the order of specification of the target icons FO1, FO2 and FO3 in this order (see FIG. 7D).

Referring back to FIG. 6, in step S109, an object operation between the source objects specified in steps S103 to S105 and the target objects specified in steps S106 to S108 is performed in the order of specification stored in each of the specification order storing section 17311 and the specification order storing section 17321.

Specifically, the operating section 176 judges whether the plurality of source objects specified by the source object specification section 1731 represent files or folders, and judges whether the plurality of target objects specified by the target object specification section 1732 represent files or folders. That is, the operating section 176 extracts a plurality of pairs of digital elements, each pair having the same specification number, and performs a digital operation between digital elements of each of the pairs.

In other words, the process is completed after performing a predetermined object operation between the files or folders represented by the source objects and the files or folders represented by the plurality of target objects in the order of specification.

More specifically, in the present embodiment, the operating section 176 performs a predetermined object operation between the source icon FI1 specified as the first source object (see FIG. 7B) and the target icon FO1 specified as the first target object (see FIG. 7D). Similarly, predetermined object operations are performed between the second source object and second target object (i.e., the icons FI2 and FO2) and between the third source object and third target object (i.e., the icons FI3 and FO3).

### 2.2. Advantage in Object Operation Apparatus according to Second Preferred Embodiment

As described, the object operation apparatus 1 according to the second preferred embodiment is capable of specifying a plurality of target objects with respect to a plurality of source objects in accordance with the flowchart shown in FIG. 6, and the operating section 176 can perform an object operation between files or folders represented by the plurality of source objects and files or folders represented by the plurality of target objects in one-to-one correspondence with each other.

That is, the present embodiment allows an object operation to be performed between a source object and a target object having the same specification number in the order of specification stored in each of the specification order storing sections 17311 and 17321.

This eliminates the need to perform the drag and drop operation in specifying each of target objects in response to specification of each of source objects, which can reduce burdens in operating objects imposed on the operator.

### Third Preferred Embodiment

Next, a third preferred embodiment of the present invention will be discussed. The object operation apparatus 1 according to this embodiment is the same as that of the first preferred embodiment except that it includes a target object attribute retrieving section 174 and a target file attribute assigning section 175, and except the process of object operation. The following discussion will be focused on these differences.

Similar components as in the object operation apparatus 1 according to the first preferred embodiment are indicated by the same reference characters. These components have already been discussed in the first preferred embodiment, and explanation thereof is omitted here.

### 3.1. Configuration of Object Operation Apparatus

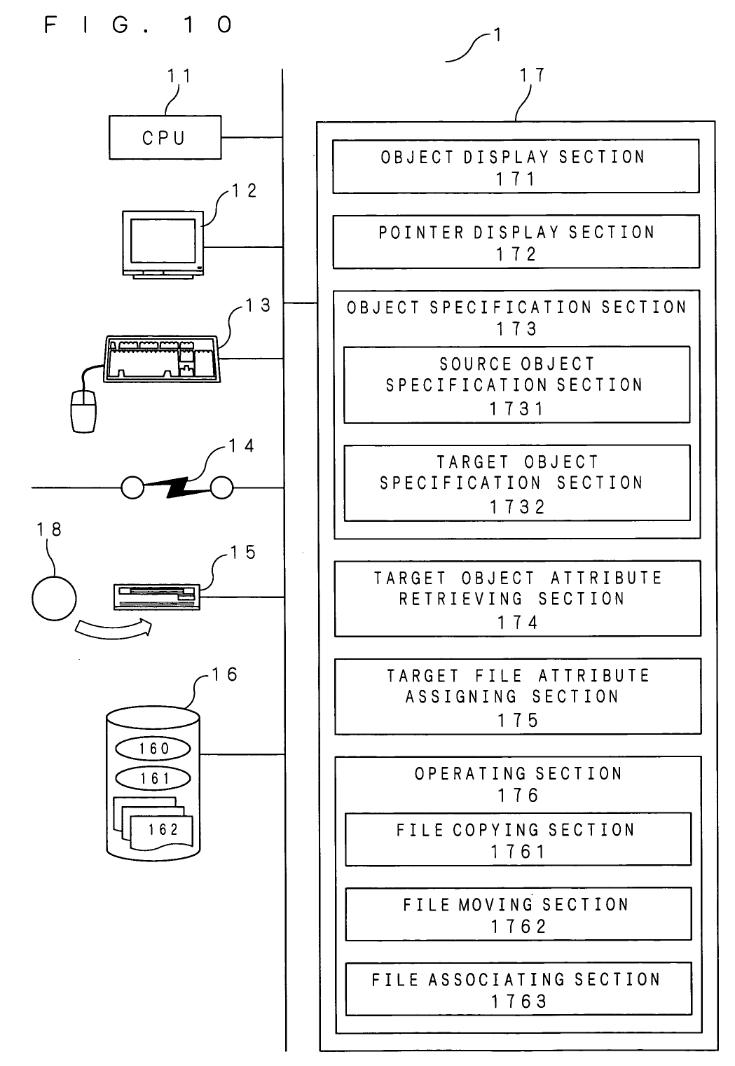

FIG. 10 shows the configuration of the object operation apparatus 1 according to the present invention. The attribute retrieving section 174 searches attributes of target objects specified by the target object specification section 1732.

Here, an attribute of an object to be searched for by the attribute retrieving section 174 is: a path that defines a folder, in the case where the object represents the folder; and the type of a data file, information on an application in which the data file is to be executed and the like, in the case where the object represents the data file.

When a target object is specified, the attribute retrieving section 174 obtains an attribute of the target object, searches for an object having the same attribute, and temporarily stores information on a retrieved target object.

In the case where the attribute assigning section 175 which will be discussed later assigns an attribute to the file or folder represented by the specified target object, the attribute retrieving section 174 makes a search for that assigned attribute.

The attribute assigning section 175 assigns an attribute to be searched for by the attribute retrieving section 174 to a file or folder represented by an object specified as a target object. The operator operates the input device 13 to operate the attribute assigning. section 175, for assigning an attribute to the file or folder represented by the target object. An attribute assigned to the file or folder represented by the target object is, for example, “being a file/folder”, or in the case where the target object represents a file, information for use in specifying a file to be associated with the file represented by the target object.

### 3.2. Process of Object Operation

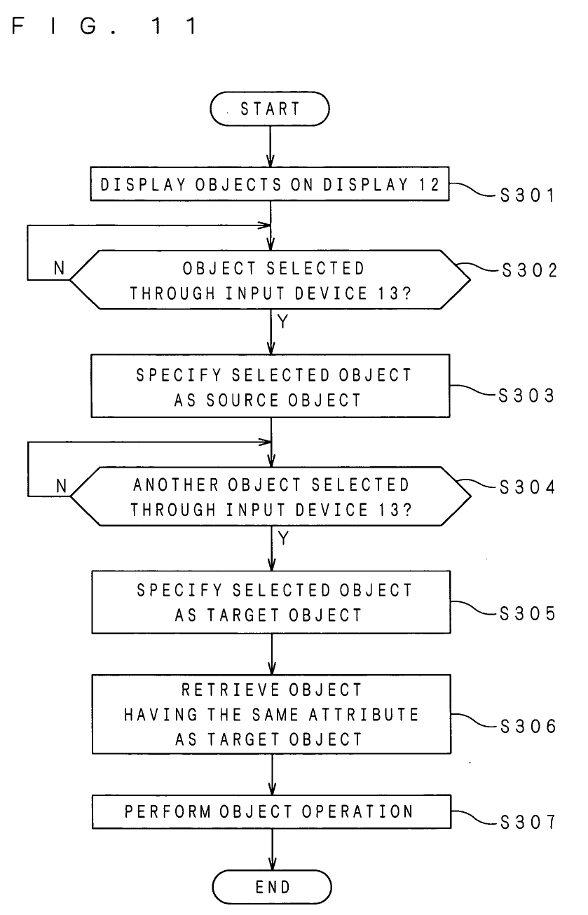

FIG. 11 is a flow chart of a process performed by the object operation apparatus 1. In step S301, objects are displayed on the display 12 prior to an object operation. Specifically, objects representing the files 162 stored in the storage 16 are displayed on the display 12 by the object display section 171.

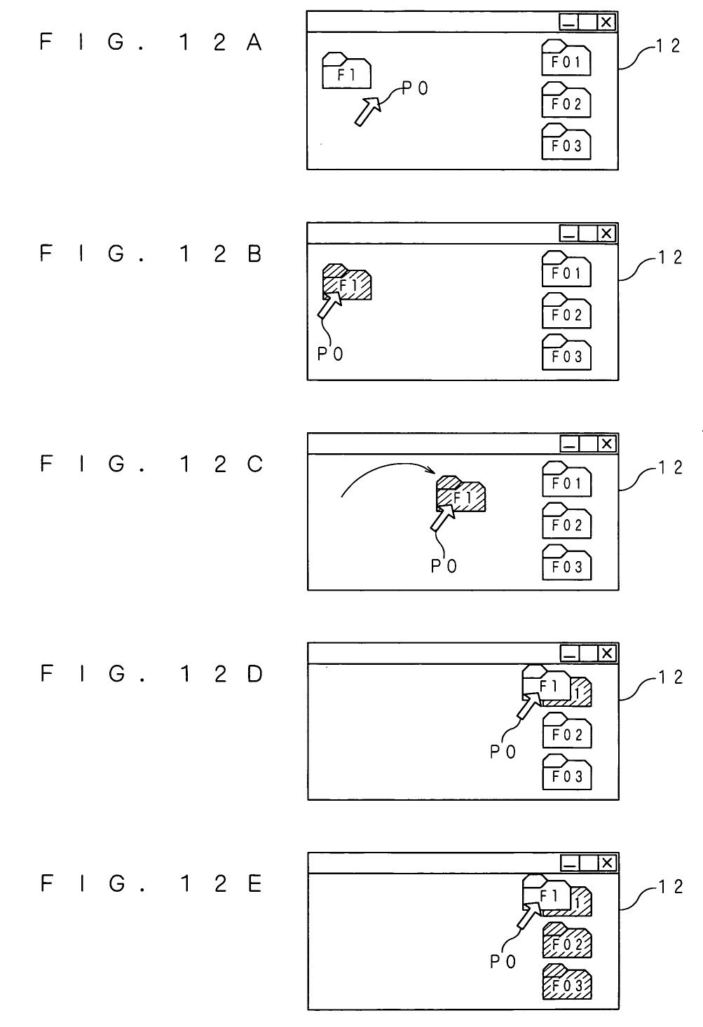

In step S302, the operator operates the input device 13 to check whether or not an icon (object) displayed on the display 12 is selected. When it is judged that an icon is highlighted or selected (see FIG. 12B), the source object specification section 1731 specifies the highlighted icon as a source object (step S303). When it is judged that no icon is highlighted or selected, step S302 is repeated.

In step S304, the source object specified in step S303 is dragged, and it is checked whether or not any object displayed on the display 12 other than the source object is highlighted or selected. When it is judged that no object is highlighted or selected, step S304 is repeated.

When it is judged that an object other than the source object is highlighted or selected (see FIG. 12D), the highlighted object is specified as a target object by the target object specification section 1732 (step S305).

In step S305, the target object specification section 1732 obtains an attribute of the specified target object from a file or folder represented by the target object, and temporarily stores the attribute. For instance, when the target object represents a file, attributes such as filename, file location defined by a path assigned to the file and file type distinguishable by its extension are stored. When the target object represents a folder, an attribute indicating that the target object is a “folder” and path information of the folder are stored.

In step S306, an object having the same attribute as the target object specified in step S305 is retrieved and selected. That is, in step S306, the attribute retrieving section 174 searches for the attribute temporarily stored in the target object specification section 1732 through objects present within a predetermined range, and, within the range, retrieves and selects an object having the same attribute as the target object specified in step S305.

In the retrieval and selection, the folder in which the target object specified in step S305 is stored may be set as the predetermined range, and files or the like present in the folder may be searched. Further, an attribute to be searched for by the attribute retrieving section 174 may be specified by the operator.

In step S307, an object operation is performed between the object specified as the target object in step S305 and the source object specified in step S303, and between the source object and each of objects retrieved and selected in step S306. That is, the operating section 176 performs an object operation between the source object and each of files or folders represented by the objects retrieved in step S306 having the same attribute as the target object.

### 3.3. Display in Object Operation

FIGS. 12A to 12E are explanatory views of an object operation on the display 12 performed by the object operation apparatus 1. FIG. 12A shows a file icon FI, folder icons FO1 to FO3 and pointer PO displayed on the display 12.

The file icon FI is displayed on the display 12 by the object display section 171 as an object representing the file 162 stored in the storage 16. The folder icons FO1 to FO3 respectively represent folders for storing files 162 in directories, and are displayed on the display 12 by the object display section 171. The pointer PO is displayed on the display 12 by the pointer display section 172.

For ease of description, only one file icon FI is displayed on the display 12, however, the number of file icons FI to be displayed is not limited to one. Similarly, less than three or more than three folder icons FO may be displayed.

FIG. 12B shows the state in which the file icon FI is selected by the pointer PO. The pointer display section 172 moves the pointer PO across the display 12 in response to an input through the input device 13 performed by the operator.

The pointer PO is then moved onto or to the vicinity of the file icon FI and the button of the pointing device of the input device 13 is pressed, so that the file icon FI is selected. Then, the object specification section 173 specifies the selected file icon FI present in the vicinity of the pointer PO as a source object.

At this time, information on the specified file icon FI is stored in the source object specification section 1731.

The object display section 171 performs a special display, for example, highlights the file icon FI, to thereby show the operator that the file icon FI is specified as a source object. FIG. 12B shows that the file icon FI is specified as a source object by hatching.

FIG. 12C shows the state in which the file icon FI pointed to by the pointer PO is dragged across the display 12 by an input through the input device 13 by the operator. When the operator makes an input to the input device 13 such that the pointer PO is moved with the button (not shown) of the pointing device of the input device 13 pressed, the object display section 171 and pointer display section 172 also move the file icon FI pointed to by the pointer PO across the display 12 with the movement of the pointer PO. This operation is similar to the conventional drag operation.

FIG. 12D shows the state in which the file icon FI is dragged to be located on the folder icon FO1 by an input through the input device 13 by the operator. Specifically, the operator operates the input device 13 to drag and continuously move the pointer PO and file icon FI shown in FIG. 12C, so that the file icon FI is located on the folder icon FO1. When the file icon FI which is the source icon is located on the folder icon FO1, the folder icon FO1 is selected. Then, the object specification section 173 specifies the folder icon FO1 as a target object.

That is, when an object is selected with a source object specified by the source object specification section 1731, the object specification section 173 activates the target object specification section 1732 such that the selected object is specified as a target object. Then, the target object specification section 1732 specifies the folder icon FO1 on which the file icon FI is located as a target object.

The object display section 171 performs a special display, for example, highlights the folder icon FO1, to thereby show the operator that the folder icon FO1 is specified as a target object. FIG. 12D shows that the folder icon FO1 specified as a target object by hatching.

FIG. 12E shows that an object operation between the file icon FI and each of the folder icons FO2 and FO3 having the same attribute as the folder icon FO1 specified by the target object specification section 1732 as the target object. In other words, FIG. 12E shows that, by specifying the folder icon FO1 as the target object, the folder icons FO2 and FO3 having the same attribute as the folder icon FO1 are also selected.

As shown in FIG. 12D, when the target object is specified by the target object specification section 1732, the attribute retrieving section 174 searches for an object having the same attribute as the target object.

In FIG. 12D, the target object specification section 1732 specifies the folder icon FO1 as a target object. Thus, the attribute retrieving section 174 obtains information on the attribute of the folder icon FO1 stored in the target object specification section 1732, and searches for an object having the same attribute as the folder icon FO1. Here, the attribute of the folder icon FO1 for use in the search made by the attribute retrieving section 174 shall be that the target object represents a “folder”.

The attribute retrieving section 174 searches objects displayed on the display 12 to retrieve the folder icons FO2 and FO3 having the same attribute as the folder icon FO1, “being a folder”.

The operating section 176 obtains the result of the search made by the attribute retrieving section 174, and causes the object display section 171 to perform a special display, for example, highlights the folder icons FO2 and FO3, to thereby show the operator that an object operation is also to be performed between the file icon FI and each of the folder icons FO2 and FO3. FIG. 12E shows that the folder icons FO2 and FO3 are also specified as target objects by hatching, in addition to the folder icon FO1.

The operator checks the display 12 as shown in FIG. 12E to confirm that an object operation is to be performed between the file icon FI and each of the folder icons FO1, FO2 and FO3. Then, the operator releases the button of the pointing device of the input device 13, so that the file icon FI is dropped onto the folder icon FO1. Then, the operating section 176 performs an object operation on the file 162 represented by the file icon FI.

Specifically, the operating section 176 activates the file copying section 1761 or the file moving section 1762 to copy or move the file 162 represented by the file icon FI to a directory represented by the folder icon FO1. Then, the operating section 176 also copies or moves the file 162 represented by the file icon FI to directories represented by the folder icons FO2 and FO3, respectively, both retrieved by the attribute retrieving section 174 having the same attribute as the folder icon FO1.

### Advantage of Object Operation Apparatus according to Third Preferred Embodiment

A file operation by the conventional drag and drop operation can only make a one-to-one or many-to-one operation, whereas the object operation apparatus 1 shown in FIG. 10 as discussed referring to FIGS. 11 and 12A to 12E is capable of searching for an attribute of a target object such as an icon on which a source icon is to be dropped, so that a retrieved object having the same attribute as the target object can be subjected to an object operation same as dropping a dragged source icon onto the target icon.

Specifically, in the present embodiment, an object having the same attribute as a target object specified by the target object specification section 1732 can be retrieved and selected, and an object operation can be performed between the source object and the target object and between the source object and the object retrieved by the attribute retrieving section 174.

This eliminates the need for the operator to operate the input device 13 to perform the drag and drop operation frequently, which can reduce burdens in operating objects imposed on the operator.

### Fourth Preferred Embodiment

Next, a fourth preferred embodiment of the present invention will be discussed. The object operation apparatus 1 according to this embodiment is the same as that of the third preferred embodiment except the process of object operation. The following discussion will be focused on this difference.

Process of Object Operation

For instance, there exists a conventional technique for associating a font and color conversion information in accordance with the ICC (International Color Consortium) profile with an original file such as a PDF (portable document format) file, thereby creating a print having a desired font or having undergone desired color conversion. The object operation apparatus 1 can also be used for associating a recipe file having a predetermined effects with such original file.

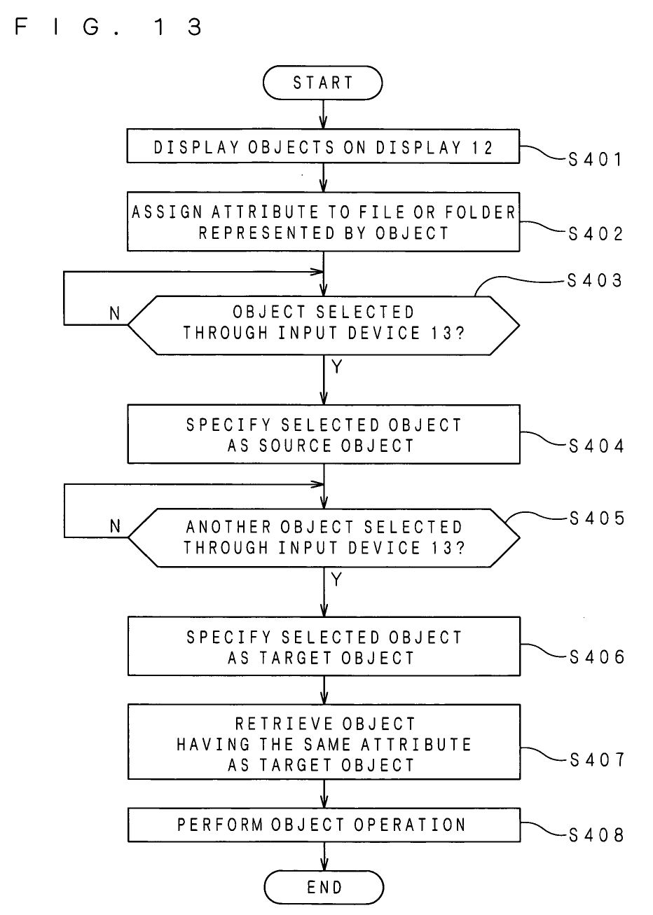

FIG. 13 is a flow chart of a process of associating a recipe file with an original file. In step S401, objects are displayed on the display 12 prior to an object operation, similarly to step S301 shown in FIG. 11.

In step S402, the attribute assigning section 175 assigns attributes for use in a search made by the attribute retrieving section 174 to an original file. That is, in step S402, the attribute assigning section 175 assigns, to an original file, such object attributes that an object is retrieved with efficiency in step S407 which will be described later.

Specifically, the operator first operates the input device 13 to activate the attribute assigning section 175 so that a search is made through original files. In other words, the operator activates the attribute assigning section 175 to be used in assigning attributes to an original file.

The attribute assigning section 175 as activated assigns attributes (e.g., subject, keyword, comment, etc.) to an original file in response to an operator's input. That is, for assigning attributes to the original file, a subject, keyword, comment and the like are written into the header of the original file.

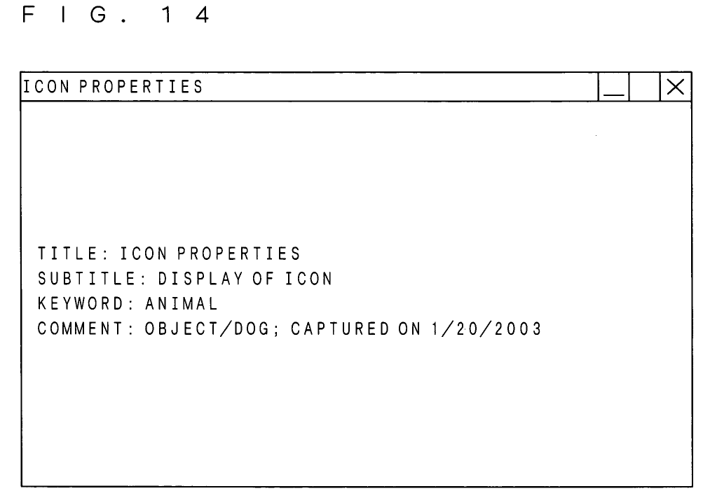

FIG. 14 shows the icon properties used in the OS, Windows (a trademark of Microsoft Corp.). As shown, the subject, keyword, comment and the like written into the header of the original file can be referred to by clicking the icon.

In this manner, information on a file can be obtained by clicking an icon representing the file. Therefore, the attribute retrieving section 174 is capable of handling an attribute written into the header of the original file as a target of search.

Attributes may be assigned to an original file in an application in which the original file has been created. Alternatively, attributes may be assigned through the use of the functions of the OS 160.

Steps S403 to S407 are similar to steps S302 to S306, and explanation thereof is thus omitted here.

In step S408, the operating section 176 associates the source object specified in step S403 with the target object specified in step S405 and the object retrieved in step S407 having the same attribute as the target object.

In the case where a file represented by the source object specified by the source object specification section 1731 is a recipe file, and a file represented by the target object specified by the target object specification section 1732 is an original file, the operating section 176 activates the file associating section 1763 to associate the recipe file with the original file.

The file associating section 1763 incorporates/links the recipe file represented by the source object in/to the original file represented by the target object and the original file represented by the retrieved object having the same attribute as the target object, to thereby associate the recipe file with the original files. Specifically, in step S408, an association is established by incorporating/linking information (path information or file contents) on the recipe file specified in step S403 in/to the original files specified in steps S406 and S407.

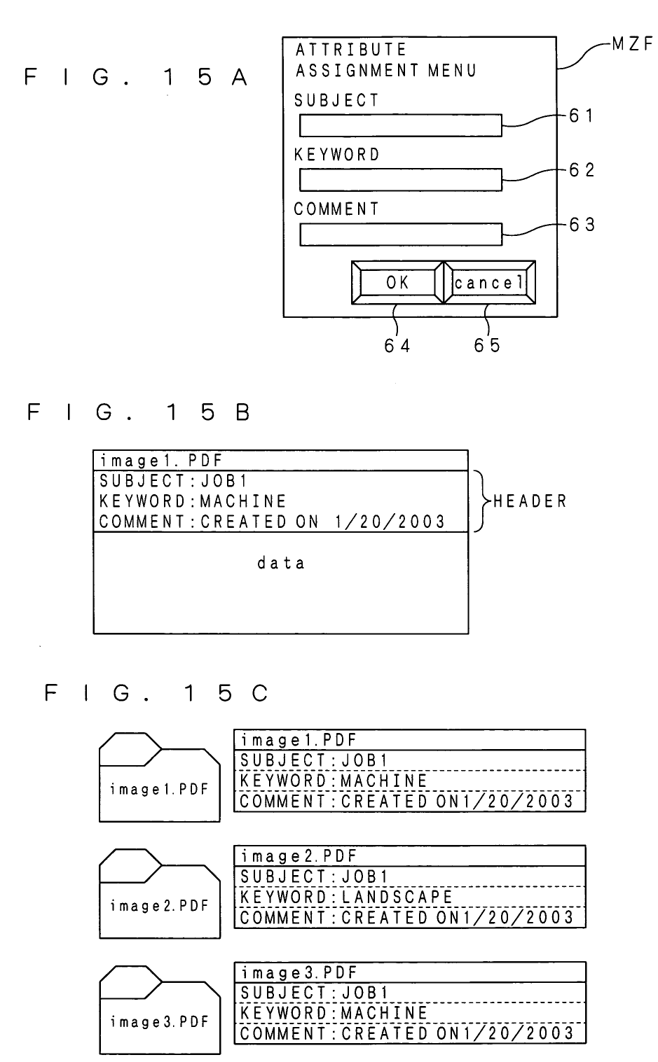

FIGS. 15A to 15C are explanatory views of a process of assigning attributes to an original file by the attribute assigning section 175. FIG. 15A shows an attribute assignment menu MZF displayed on the display 12 for use in assigning attributes to an original file to be searched for by the attribute retrieving section 174. Assigned attributes are used as search keys by the attribute retrieving section 174.

The attribute assignment menu MZF has a subject input box 61, a keyword input box 62, a comment input box 63, an OK button 64 and a cancel button 65.

The subject input box 61 is used to input a subject to be assigned to an original file as an attribute. The operator operates the input device 13 to input the subject of the original file as an attribute to be searched for by the attribute retrieving section 174. That is, the operator operates the input device 13 to input a desired character string or the like into the subject input box 61, so that the character string can be assigned to the original file as a “subject” attribute.

The keyword input box 62 is used to input a keyword to be assigned to the original file as an attribute. The comment input box 63 is used to input a comment to be assigned to the original file as an attribute. By inputting character strings and the like into these input boxes 62 and 63, a “keyword” attribute and a “comment” attribute can be assigned to the original file.

Upon completion of input into the subject input box 61, keyword input box 62 and comment input box 63, the operator operates the input device 13 to press the OK button 64. When the OK button 64 is pressed, the attribute assigning section 175 writes the text having been input in the subject input box 61, keyword input box 62 and comment input box 63 into the header of the original file and finishes the display of the attribute assignment menu MZF. When the cancel button 65 is pressed by the operator, the attribute assigning section 175 deletes the text having been input to the attribute assignment menu MZF, and finishes the display of the attribute assignment menu MZF without assigning any attribute to the original file.

FIG. 15B shows that attributes to be searched for by the attribute retrieving section 174 have been written into the header of the original file in response to an input into the attribute assignment menu MZF. In other words, FIG. 15B visually shows the attributes assigned to the original file in accordance with the attribute assignment menu MZF. Here, attributes such as a subject “JOB1”, a keyword “machine” and a comment “created on Jan. 20, 2003” are written into an original file “image1.pdf”.

FIG. 15C shows icons representing original files “image1.pdf”, “image2.pdf” and “image3.pdf”, respectively, and their icon properties displayed on the display 12.

Attributes are assigned to the original files “image1.pdf”, “image2.pdf” and “image3.pdf” in accordance with the attribute assignment menu MZF shown in FIG. 15A. That is, the attributes are written into headers of the respective original files. Accordingly, the icon properties of FIG. 15C show the attributes written into the header of the original files to be searched for by the attribute retrieving section 174.

Specifically, attributes which can be set by the attribute assignment menu MZF shown in FIG. 15A are written into the header of each of the original files “image1.pdf”, “image2.pdf” and “image3.pdf”. Therefore, as shown in FIG. 15C, displaying the respective icon properties, attributes to be used as search keys by the attribute retrieving section 174 are displayed in dialogs.

Here, the displayed properties show that the keyword “machine” for the “image1.pdf” file, “landscape” for the “image2.pdf” file, and “machine” for the “image3.pdf” file are input by the operator in correspondence with images stored in the respective files.

That is, the operator uses the attribute assignment menu MZF to set the “keyword” attribute: “machine”; “landscape”; and “machine” for the “imag1.pdf” file, “image2.pdf” file and “image3.pdf” file, respectively, in correspondence with images stored in the respective files.

In the case where the headers of the respective original files include a different attribute from one another, it is desirable for the operator to operate the input device 13 such that the attribute retrieving section 174 uses the different attribute as a target of search. Here, the “keyword” attribute shall be selected as a target of search by the attribute retrieving section 174.

Specifically, it is desirable to specify an attribute to be used as a search key by the attribute retrieving section 174 such that a desired original file can be retrieved from a plurality of original files. In the respective files shown in FIG. 15C, using the “keyword” attribute as a search key allows a desired file to be retrieved from the plurality of original files.

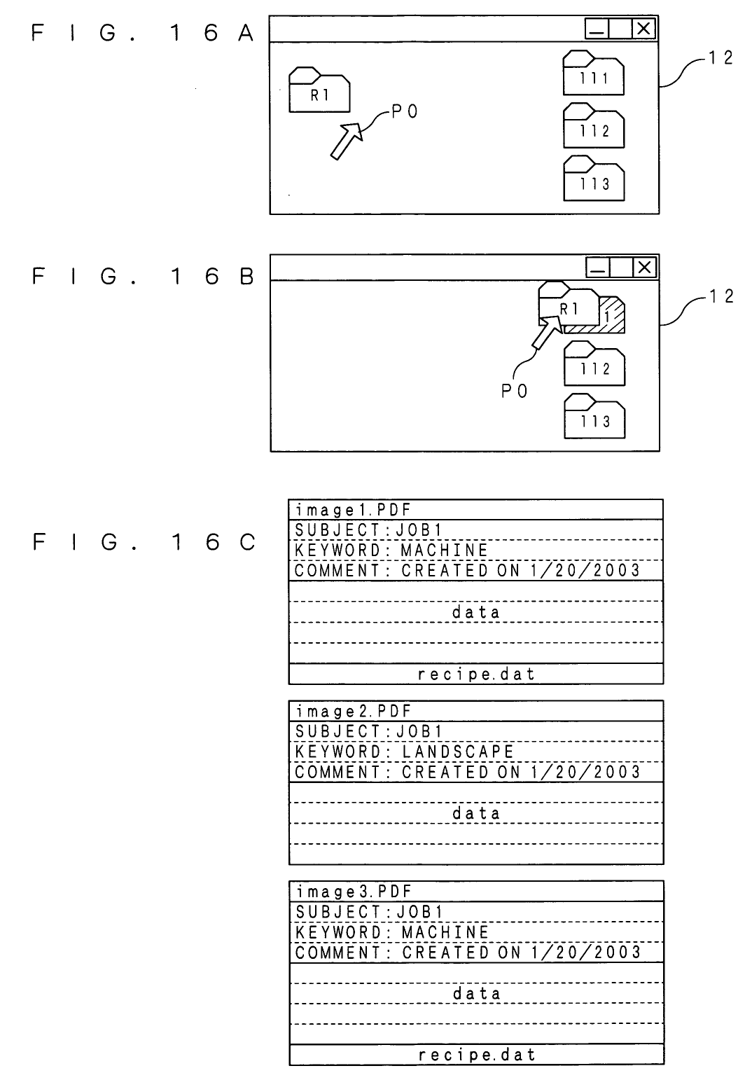

FIGS. 16A to 16C are explanatory views of associating a recipe file with original files by the file associating section 1763.

FIG. 16A shows that the display 12 displays a recipe icon RI representing an image-expressing setup file “recipe.dat” which is a recipe file, as a source object, and image icons II1 to II3 representing the original files “image1.pdf”, “image2.pdf” and “image3.pdf”, respectively, which are original files, as target objects. Although, the three image icons II1 to II3 representing the original files are displayed here, the number of icons to be displayed may be two or less, or four or more.

FIG. 16B shows that the recipe icon RI is subjected to an operation similar to the drag operation of the icon as shown in FIGS. 12B to 12E. As shown, the recipe icon RI held by the pointer PO is specified as a source object and is located on the image icon II1. The target object specification section 1732 specifies the image icon II1 as a target object.

With the above specification, the attribute retrieving section 174 searches for another object having the same attributes as the image icon II1 based on the attributes of the specified object temporarily stored in the target object specification section 1732.

Specifically, the attribute retrieving section 174 uses the “keyword” attribute written in the header of the file as a target of search (search key), to search for an image icon representing a file having the same keyword “machine” as that written in the header of the “image1.pdf” file represented by the image icon II1. The image icon II3 representing the “image3.pdf” file is thereby retrieved.

As a result, an object with respect to which an object operation of the recipe icon RI is to be performed by the operating section 176 is specified. The object display section 171 provides an indication to be paid attention to by the operator.

The operator confirms the indication and drops the recipe icon RI onto the image icon II1. Then, the file associating section 1763 executes an operation for associating the recipe file “recipe.dat” with each of the original files “image1.pdf” and “image3.pdf”.

FIG. 16C shows the result of the operation performed by the file associating section 1763 for associating the recipe file “recipe.dat” represented by the recipe icon RI with each of the original file “image1.pdf” represented by the image icon II1 and original file “image3.pdf” represented by the image icon II3. In other words, FIG. 16C shows the result of the operation performed by the file associating section 1763 for adding information on the recipe file “recipe.dat” into each of the original files “image1.pdf” and “image3.pdf”.

As shown in FIG. 16C, the recipe file “recipe.dat” is not associated with the “image2.pdf” file. In contrast, the “image3.pdf” file having the same attribute (keyword) as the “image1.pdf” file has the recipe file “recipe.dat” incorporated therein similarly to the “image1.pdf” file, although the recipe file is not directly associated therewith.

Specifically, the attribute retrieving section 174 retrieves the image icon II3 having the same attribute as the image icon II1 specified as a target object. Accordingly, the “recipe.dat” can be associated with the original file “image3.pdf” represented by the image icon II3 retrieved by the attribute retrieving section 174 as well as the “image1.pdf” file specified by the target object specification section 1732.

Therefore, the “image3.pdf” file can be subjected to an association without an operator's direct specification. As a result, the recipe file is associated with a plurality of original files by specifying only one target object.

### 4.2. Advantage of Object Operation Apparatus according to Fourth Preferred Embodiment

A file operation by the conventional drag and drop operation can only make a one-to-one or many-to-one operation, whereas the object operation apparatus 1 shown in FIG. 10 as discussed referring to FIGS. 13 and 16A to 16C is capable of searching for an attribute of a target object such as an icon on which a source icon is to be dropped, so that a retrieved object having the same attribute as the target object can be subjected to an object operation same as dropping a dragged source icon onto the target icon.

Specifically, in the present embodiment, an optimum file attribute that corresponds to an original file can previously be determined by the attribute assigning section 175. Further, the attribute retrieving section 174 uses the attribute determined by the attribute assigning section 175, thereby retrieving and selecting suitably and effectively an object having the same attribute as the target object. Then, an object operation can be performed between the source object and each of the target object and the object selected by the attribute retrieving section 174.

Therefore, the operator is not required to operate the input device 13 to perform the drag and drop operation frequently. This can reduce burdens in operating objects imposed on the operator.

### 5. Modification

The first to fourth preferred embodiments have respectively discussed the operations of the object operation apparatus 1, however, the object operation apparatus 1 may perform the respective operations discussed in the first to fourth preferred embodiments at the same time.

Further, the first preferred embodiment has described referring to FIG. 2 that a plurality of target objects are specified by the drag and drop operation. However, after specifying a plurality of target objects, a shortcut menu displayed by pressing a key (not shown) of the input device 13 may be executed, so that an object operation may be performed between a file represented by a source object and each of files represented by the plurality of target objects. This can be true for the second to fourth preferred embodiments.

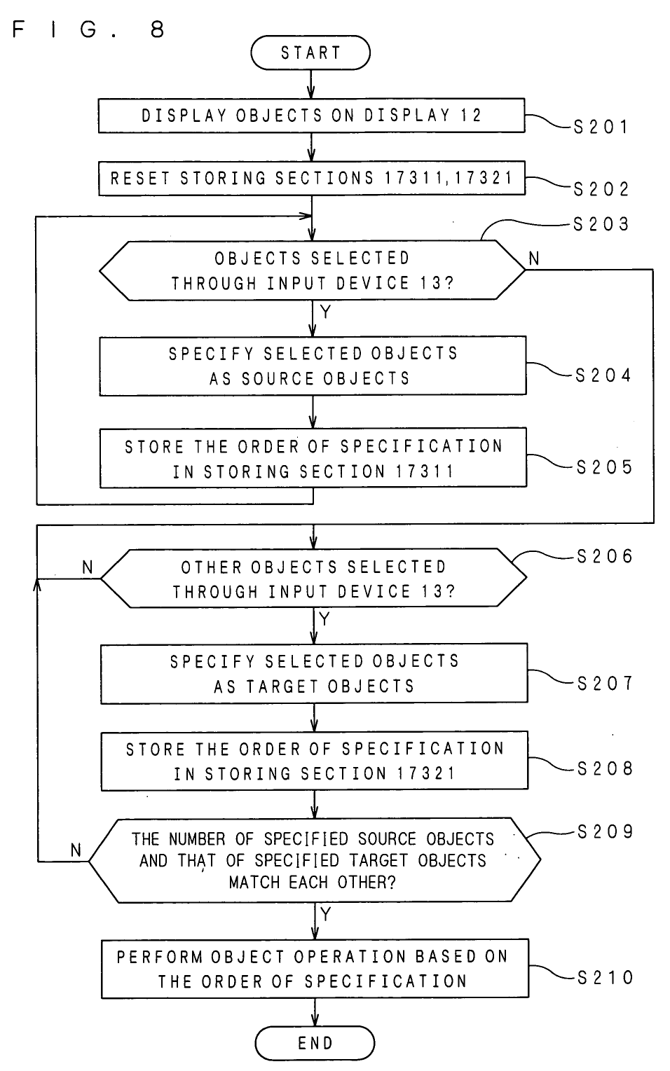

Furthermore, the first preferred embodiment has described referring to FIG. 6 that a plurality of target objects are specified by a drag and drop operation, however, an object operation may be performed in accordance with the flow chart shown in FIG. 8 between files or folders represented by a plurality of source objects and files or folders represented by a plurality of target objects in one-to-one correspondence with each other.

In the flow chart shown in FIG. 8, steps S206 to S208 corresponding to steps S106 to S108 shown in FIG. 6 can be repeated. With this flow chart, a plurality of target objects can be specified sequentially, not continuously. To specify target objects sequentially, the “Ctrl” key on the keyboard of the input device 13 may be pressed with the pointer PO located on an object to be specified as a target object in step S206, for example.

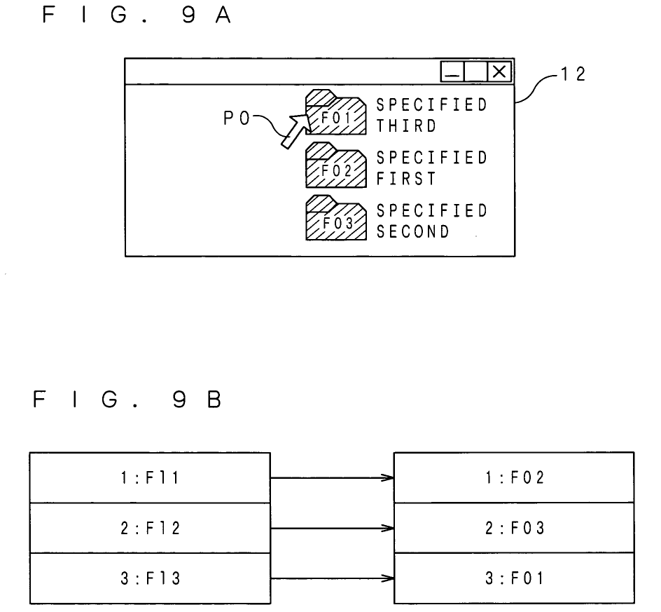

Specifically, as shown in FIG. 9A, when the icon FO2 is specified first as a target icon among the target icons FO1 to FO3 (steps S206 and S207), the target icon FO2 is stored in the specification order storing section 17321 as a first target icon (step S208).

When the icon FO3 is next specified as a target icon (back to step S206, S207), the target icon FO3 is stored in the specification order storing section 17321 as a second target object (step S208).

Then, the icon FO1 is specified as the last target object (back to step S206, S207). The target icon FO1 is then stored in the specification order storing section 17321 as a third target object (step S208).

In summary, as shown in FIG. 9B, the target objects FO2, FO3 and FO1 to be stored in the specification order storing section 17321 are specified in this order.

In step S209, the operator judges whether or not the number of specified source objects stored in the specification order storing section 17311 and the number of specified target objects stored in the specification order storing section 17321 match each other. If not, the process returns to step S206. If yes, the process proceeds into step S210.

In step S210, the operating section 176 performs an object operation on files or folders represented by a plurality of source objects in the order of specification stored in the specification order storing section 17311 in one-to-one correspondence with files or folders represented by a plurality of target objects in the order of specification stored in the specification order storing section 17321.

Therefore, as shown in FIG. 9B, the correspondence between the source objects and target objects in step S210 is: FI1 and FO2; FI2 and FO3; and FI3 and FO1. Accordingly, the object operation is performed by the operating section 176 between the icons FI1, FI2 and FI3, and the icons FO2, FO3 and FO1 in one-to-one correspondence in this order.

As described, the object operation apparatus shown in FIG. 1 is capable of performing the process shown in the flow chart of FIG. 8 to specify target objects in an arbitrary order, regardless of the order of specification of source objects. This eliminates the need to perform the drag and drop operation repeatedly, which can reduce burdens in operating objects imposed on the operator.

Further, the first to fourth preferred embodiments have described that one or three source objects and three target objects are displayed on the display 12, however, the number of source objects and that of target objects are not limited to these numbers.

Furthermore, although the first preferred embodiment has described that the “Shift” key and “Ctrl” key on the keyboard of the input device 13 are used to specify target objects, other keys of the input device 13 may be used instead.

Still further, the first to fourth preferred embodiments have described that the drag and drop operation is used in an object operation, however, a shortcut menu may be used instead.

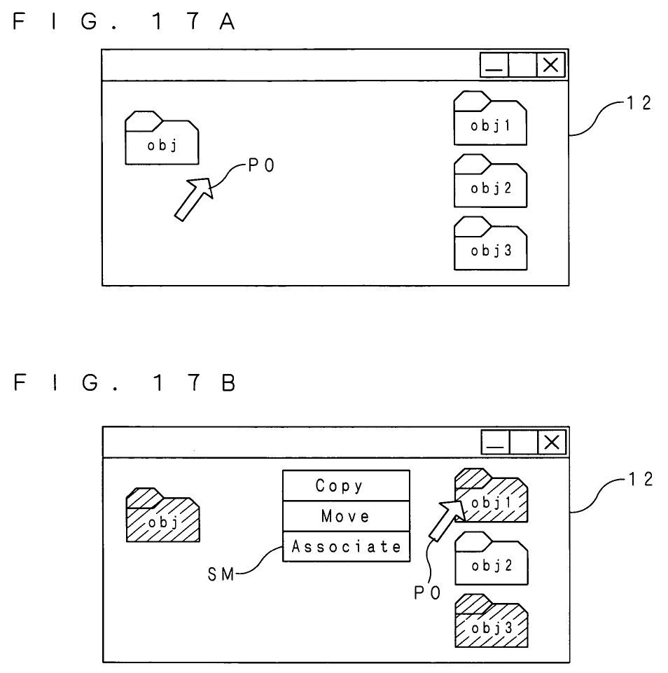

FIGS. 17A and 17B illustrates the case of using a shortcut menu in an object operation. FIG. 17A shows a state similar to that of FIG. 12A, and then an object obj is specified as a source object similarly to the file icon FI shown in FIG. 12B. FIG. 17B shows a state in which only the pointer PO is moved onto an object obj1 and a shortcut menu is displayed by an input through the input device 13 by the operator.

As shown in FIG. 17B, when the operator operates the input device 13 to move the pointer PO alone onto the object obj and to display the shortcut menu, the target object specification section 1732 specifies the object obj1 for which the shortcut menu is being displayed as a target object. Then, the attribute retrieving section 174 searches for an object having the same attribute as the object obj1, and the operating section 176 also performs an object operation on a retrieved object obj3 similarly to the object obj1.

With such an object operation method using a shortcut menu, the operator is not required to operate the input device 13 to perform the shortcut menu operation frequently. This can reduce burdens imposed on the operator.

While the invention has been shown and described in detail, the foregoing description is in all aspects illustrative and not restrictive. It is therefore understood that numerous modifications and variations can be devised without departing from the scope of the invention.

1. An object operation apparatus in a computer system comprising:
a display for displaying thereon objects symbolically representing digital elements, respectively;
a manual input device;
a first specification section for specifying a first object among said objects displayed on said display in response to a first manual operation through said manual input device;
a second specification section for continuously moving said first object to the vicinity of a plurality of second objects among said objects displayed on said display in response to a second manual operation through said manual input device performed with said first object kept specified, thereby specifying said plurality of second objects; and
an operating section for performing a digital operation between a first digital element represented by said first object and each of a plurality of second digital elements represented by said plurality of second objects, respectively.

2. The object operation apparatus according to claim 1, wherein said manual input device includes:
a key device; and
a pointing device, and
said plurality of second objects are specified by causing said first object held by said pointing device to sweep over said plurality of second objects while a continuous selection signal transmitted from said key device is active.

3. The object operation apparatus according to claim 1, wherein said manual input device includes:
a key device; and
a pointing device,
said plurality of second objects are specified by causing said first object held by said pointing device to sequentially visit said plurality of second objects in synchronization with an intermittent selection signal transmitted from said key device, and
said digital operation is sequentially performed between said first object and each of said plurality of second objects in response to a visit of said first object to each of said plurality of second objects.

4. The object operation apparatus according to claim 1, wherein
said first object symbolically represents a digital file,
said plurality of second objects symbolically represent a plurality of digital folders, respectively, and
said operating section performs said digital operation by copying said digital file to each of said plurality of digital folders.

5. The object operation apparatus according to claim 1, wherein
said first object symbolically represents a digital file,
said plurality of second objects symbolically represent a plurality of digital folders, respectively, and
said operating section performs said digital operation by moving said digital file to each of said plurality of digital folders.

6. The object operation apparatus according to claim 1, wherein
said first object symbolically represents a first digital file,
said plurality of second objects symbolically represent a plurality of second digital files, respectively, and
said operating section performs said digital operation by associating information on said first digital file with each of said plurality of second digital files.

7. An object operation apparatus in a computer system, comprising:
a display for displaying thereon objects symbolically representing digital elements, respectively;
a manual input device;
a first specification section for specifying a plurality of first objects among said objects displayed on said display in response to a first manual operation through said manual input device;
a second specification section for moving said plurality of first objects to the vicinity of a plurality of second objects among said objects displayed on said display in response to a second manual operation through said manual input device performed with said plurality of first objects kept specified, thereby specifying said plurality of second objects; and
an operating section for performing a digital operation between a plurality of first digital elements represented by said plurality of first objects, respectively, and a plurality of second digital elements represented by said plurality of second objects, respectively, in one-to-one correspondence with each other, on the basis of a correspondence between said plurality of first objects and said plurality of second objects, wherein
said plurality of first objects and said plurality of second objects are equal in number.

8. The object operation apparatus according to claim 7, wherein
said first specification section includes a first storing section for storing the order of specification of said plurality of first objects,
said second specification section includes a second storing section for storing the order of specification of said plurality of second objects, and
said operating section extracts a plurality of pairs of digital elements in the order of specification stored as said correspondence in each of said fist and second storing sections, each pair including one of said plurality of first digital elements and one of said plurality of second digital elements, both having the same specification number, thereby performing said digital operation on each of said plurality of pairs of digital elements.

9. The object operation apparatus according to claim 8, wherein
said plurality of first objects symbolically represent a plurality of digital files, respectively,
said plurality of second objects symbolically represent a plurality of digital folders, respectively,
said operating section performs said digital operation by copying said plurality of digital files to said plurality of digital folders on the basis of said correspondence.

10. The object operation apparatus according to claim 8, wherein
said plurality of first objects symbolically represent a plurality of digital files,
respectively,
said plurality of second objects symbolically represent a plurality of digital folders, respectively,
said operating section performs said digital operation by moving said plurality of digital files to said plurality of digital folders on the basis of said correspondence.

11. The object operation apparatus according to claim 8, wherein
said plurality of first objects symbolically represent a plurality of first digital files, respectively,
said plurality of second objects symbolically represent a plurality of second digital files, respectively, and
said operating section performs said digital operation by associating said plurality of first digital files with said plurality of second digital files on the basis of said correspondence.

12. An object operation method in a computer system, comprising the steps of:
a) displaying objects symbolically representing digital elements, respectively, on a display;
b) specifying a first object among said objects displayed on said display in response to a first manual operation through a manual input device;
c) continuously moving said first object to the vicinity of a plurality of second objects among said objects displayed on said display in response to a second manual operation through said manual input device performed with said first object kept specified, thereby specifying said plurality of second objects; and
d) performing a digital operation between a first digital element represented by said first object and each of a plurality of second digital elements represented by said plurality of second objects, respectively.

13. An object operation method in a computer system, comprising the steps of:
a) displaying objects symbolically representing digital elements, respectively, on a display;
b) specifying a plurality of first objects among said objects displayed on said display in response to a first manual operation through said manual input device;
c) moving said plurality of first objects to the vicinity of a plurality of second objects among said objects displayed on said display in response to a second manual operation through said manual input device performed with said plurality of first objects kept specified, thereby specifying said plurality of second objects, said plurality of first objects and said plurality of second objects being equal in number; and
d) performing a digital operation between a plurality of first digital elements represented by said plurality of first objects, respectively, and a plurality of second digital elements represented by said plurality of second objects, respectively, in one-to-one correspondence with each other, on the basis of a correspondence between said plurality of first objects and said plurality of second objects.

14. A program for performing an object operation in a computer system, said program causing said computer system to execute the steps of:
a) displaying objects symbolically representing digital elements, respectively, on a display;
b) specifying a first object among said objects displayed on said display in response to a first manual operation through a manual input device;
c) continuously moving said first object to the vicinity of a plurality of second objects among said objects displayed on said display in response to a second manual operation through said manual input device performed with said first object kept specified, thereby specifying said plurality of second objects; and
d) performing a digital operation between a first digital element represented by said first object and each of a plurality of second digital elements represented by said plurality of second objects, respectively.

15. A program for performing an object operation in a computer system, said program causing said computer system to execute the steps of:
a) displaying objects symbolically representing digital elements, respectively, on a display;
b) specifying a plurality of first objects among said objects displayed on said display in response to a first manual operation through said manual input device;
c) moving said plurality of first objects to the vicinity of a plurality of second objects among said objects displayed on said display in response to a second manual operation through said manual input device performed with said plurality of first objects kept specified, thereby specifying said plurality of second objects, said plurality of first objects and said plurality of second objects being equal in number; and
d) performing a digital operation between a plurality of first digital elements represented by said plurality of first objects, respectively, and a plurality of second digital elements represented by said plurality of second objects, respectively, in one-to-one correspondence with each other, on the basis of a correspondence between said plurality of first objects and said plurality of second objects.

16. An object operation apparatus in a computer system, comprising:
a display for displaying thereon objects symbolically representing digital elements, respectively;
a manual input device;
a first specification section for specifying a first object among said objects displayed on said display in response to a first manual operation through said manual input device;
a second specification section for moving said first object to the vicinity of a second object among said objects displayed on said display in response to a second manual operation through said manual input device performed with said first object kept specified, thereby specifying said second object;
a retrieving section for searching said computer system to retrieve a third object having the same attribute as said second object; and
an operating section for performing a digital operation between a first digital element represented by said first object and each of second and third digital elements represented by said second and third objects, respectively.

17. The object operation apparatus according to claim 16 further comprising
an attribute assigning section for assigning an attribute to said second digital element, wherein
said retrieving section retrieves said third object on the basis of said attribute assigned to said second digital element by said attribute assigning section.

18. The object operation apparatus according to claim 17, wherein
said first object symbolically represents a digital file,
said second and third objects symbolically represent digital folders, respectively, and
said operating section performs said digital operation by copying said digital file to each of said digital folders.

19. The object operation apparatus according to claim 17, wherein
said first object symbolically represents a digital file,
said second and third objects symbolically represent digital folders, respectively, and
said operating section performs said digital operation by moving said digital file to each of said digital folders.

20. The object operation apparatus according to claim 17, wherein
said first object symbolically represents a first digital file,
said second and third objects symbolically represent second and third digital files, respectively, and
said operating section performs said digital operation by associating information on said first digital file with each of said second and third digital files.

21. An object operation method in a computer system, comprising the steps of:
a) displaying objects symbolically representing digital elements, respectively, on a display;
b) specifying a first object among said objects displayed on said display in response to a first manual operation through said manual input device;
c) moving said first object to the vicinity of a second object among said objects displayed on said display in response to a second manual operation through said manual input device performed with said first object kept specified, thereby specifying said second object;
d) searching said computer system to retrieve a third object having the same attribute as said second object; and
e) performing a digital operation between a first digital element represented by said first object and each of second and third digital elements represented by said second and third objects, respectively.

22. A program for performing an object operation in a computer system, said program causing said computer system to execute the steps of:
a) displaying objects symbolically representing digital elements, respectively, on a display;
b) specifying a first object among said objects displayed on said display in response to a first manual operation through said manual input device;
c) moving said first object to the vicinity of a second object among said objects displayed on said display in response to a second manual operation through said manual input device performed with said first object kept specified, thereby specifying said second object;
d) searching said computer system to retrieve a third object having the same attribute as said second object; and
e) performing a digital operation between a first digital element represented by said first object and each of second and third digital elements represented by said second and third objects, respectively.
